(19) United States
(12) Patent Application Publication
(10) Pub. No.: US 2004/0172405 A1
(43) Pub. Date: Sep. 2, 2004

(54) Publishing system and method

(76) Inventor: Howard E. Farran, Phoenix, AZ (US)

Correspondence Address: FENNEMORE CRAIG, 3003 NORTH CENTRAL AVENUE, SUITE 2600, PHOENIX, AZ, 85012, US

(21) Appl. No.: 10/805,092

(22) Filed: Mar. 19, 2004

Related U.S. Application Data
(60) Provisional application No. 60/455,773, filed on Mar. 19, 2003.

(51) Int. Cl. G06F 17/00

(52) U.S. Cl. 707/100

(57) ABSTRACT

A publishing system for creating a printed publication with input and content from a substantial portion of the readership via an online forum, and a method of obtaining and selecting content that will be highly likely to interest readers of a subject area.

### RELATED APPLICATIONS

This application claims the benefit of U.S. Provisional Application No. 60/455,773, filed Mar. 19, 2003, entitled “Publishing System,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

There are thousands of publications catering to different interests and covering various subjects and topics. Typically, in the past, content for such publications has been provided by professional writers who submit articles for publication. Often, such professional writers use their own judgment in selecting what specific subjects and topics to write about, or they are given some direction or assignment as to what subject matter they should write about. In the latter case, the assignments are often influenced by a relatively small group of people who manage the publication and “push” content that they perceive will interest the readers, or that will please the advertisers in the publication.

However, the managers and professional writers of many such publications often fail to provide the content that most interests their readers. Publishers are often out of touch with the issues and topics that would be most popular with the readership.

Further, for many topics involving specialized knowledge and expertise (such as, for example, the field of dentistry, etc.), publishers, due to their lack of such specialized knowledge and expertise, often fail to provide content in their publications most relevant to their readership and target audience. Even publishers and writers with a very high degree of specialized knowledge, expertise and experience in the subject area will not approach the knowledge and expertise of the collective readership taken as a whole, and therefore such publishers may fail to provide the most relevant content. In fact, even those publishers and writers that do have such specialized knowledge and expertise may still not know what issues are most important to the readers.

Typically, publishers receive only limited feedback from readers in the form of suggestions from a relatively very small number of proactive readers and occasional influxes of editorial letters, etc., after a particularly controversial article or feature has been printed in the publication. Readers often lack motivation to give feedback to publications, especially since the effort typically involved provides a significant barrier. Although many readers may desire the recognition and prestige of having a letter to the editor or article printed, many feel the effort involved in carefully crafting a letter, coupled with the slim odds of such a letter being selected to be printed, does not justify the endeavor.

There is a need, therefore, for a publishing system and method that can address the shortcomings of previous systems and methods. It is an object and feature of the present invention, therefore, to provide a system and method for creating a printed publication with input and content from a substantial portion of the readership of such printed publication.

It is a further object and feature of the present invention to provide such a system and method by which it is easy and convenient for interested readers to provide content and feedback for such printed publication.

It is still a further object and feature of the present invention to provide such a system and method that allows a publisher to select and print content that will be very likely to interest the readership.

It is a further object and feature of the present invention to provide such a system and method that provides incentives for interested readers to contribute content to such a printed publication.

A further object and feature of the present invention is to provide such a system and method that is efficient, inexpensive, and handy.

Additional objects and advantages of the invention will be set forth in the description that follows, and in part will be apparent from the description, or may be learned by practice of the invention. The objects and advantages of the invention may be realized and obtained by means of the apparatus and methods pointed out in the appended claims.

### SUMMARY

To achieve the foregoing objects, and in accordance with the purposes of the invention as embodied and broadly described in this document, there is provided a method of publishing a magazine comprising, in combination, the steps of: providing a printed magazine to a substantial portion of a vertical market that includes entities having interest in a common subject area; printing in the magazine portions of selected threads from an online forum in the subject area; and printing advertising in the magazine for at least one advertiser offering at least one product to the entities in the subject area. The method can further include the step of providing an online forum in the subject area wherein the online forum allows a subset of the entities to be contributors to the threads.

According to one advantageous method, the magazine and the online forum are provided substantially free to the entities in the subject area. Contributors to the threads of the online forum include at least one subset of such entities. As a requirement of participation in the online forum, the contributors agree to permit the magazine publisher to print any content they contribute to the threads and further agree that the online forum shall have rights to publish any such content to the online forum. As a further requirement, the contributors agree to assign any intellectual property rights to the online forum for any content that they contribute to the online forum. Also, the entities must demonstrate qualification in the subject area to access the online forum. For example, the entities are required to correctly answer a qualifying question in the subject area before being allowed to participate in the online forum.

Also, according to an advantageous method, a criterion for selecting threads from an online forum is the relative popularity of the threads. The popularity of the threads can be measured by the number of thread entries or by the number of entities contributing to such threads. Advertising for products related to the portions of selected threads is available in the print magazine proximal to the portions of selected threads in the magazine. The online forum is substantially devoid of advertising. The portions of selected threads are printed in the magazine in a format recognizably similar to threads in the online forum. The portions of selected threads printed in the magazine can include screen names of entities that contributed the portions of selected threads, photographs of those entities, geographic locations of those entities, registration information of those entities and/or user profiles of those entities who contributed such portions of selected threads. The portions of selected threads printed in such magazine also can include thread information about the portions of selected threads, such as a post number, the total number of posts in the thread and times when the portions of selected threads were posted. The portions of selected threads printed in the magazine can be ordered chronologically. A different background shade printed in the magazine can be used to distinguish portions of selected threads contributed by different entities. Alternating background shades can assist in distinguishing between posts successively printed in the magazine.

Another preferred method of the invention includes the steps of: ranking online forum threads by popularity; selecting a subset of the most popular topics for publication; editing the content; and printing the content in a printed publication in a format recognizably similar to a format of the online forum. The printed publication and the online forum can be provided substantially free. Contributors to the online forum agree in advance of contributing any content to the online forum to permit the printing of content contributed to the threads. Popularity of the threads can be measured, such as by the number of thread entries or the number of different contributors to the threads. Advertising in the printed publication for products related to content can be located proximally to the content in the printed publication. Preferably, the online forum is substantially devoid of advertising. The printed content can include screen names of entities that contributed the content and thread information about the forum threads. The thread information can include a post number, a total number of posts in the thread and the times when the portions of selected threads were posted. Alternating background shades can assist readers to identify content as originating from online forum. Preferably, the portions of selected threads include entries by at least three contributors.

In accordance with another preferred method, the invention provides a method of publishing content including the steps of: providing an online forum; selecting a subset of online subject matter from the online forum for publication; editing the content; and printing the content in a format recognizably similar to the online format.

In accordance with a preferred embodiment of the invention, a system is provided for publishing content. The system includes publishing means for providing a printed magazine to a substantial portion of a vertical market including entities having interest in a common subject area, means for obtaining from an online forum in the subject area portions of selected threads in the subject area, content means for printing in the magazine portions of the selected threads from an online forum in the subject area, and advertising means for making advertising in the magazine available to advertisers offering products to the entities in the subject area.

In accordance with another preferred embodiment, the invention provides a system for publishing content including: means for providing an online forum; means for selecting a subset of online subject matter from the online forum for publication; means for editing the content; and means for printing the content in a format recognizably similar to the online format.

### BRIEF DESCRIPTION OF THE DRAWINGS

FIG. 1 is a simplified functional diagram of a preferred computer network for practicing the present invention, showing a web server connected to other computer systems via the Internet.

FIG. 2 is a simplified functional block diagram of a web server configured according to a preferred embodiment of the present invention.

FIG. 3 is a simplified functional diagram of a portion of a preferred embodiment of the present invention, showing the web server of FIG. 2 connected to users' computer systems via the Internet.

FIG. 4 is a simplified relational diagram of a preferred embodiment of the present invention, showing relationships between and among interested readers, registered users, a magazine printer, a website, a website manager and related product advertisers.

FIG. 5 is a simplified relational diagram of an alternate preferred embodiment of the present invention, showing relationships between and among interested readers, registered users, a publisher, a magazine printer, a website, a website manager and related product advertisers.

FIG. 6 is flow diagram showing the steps involved in using website threads to select topics for publication in a print magazine, selling advertising and publishing the print magazine, all according to the present invention.

FIGS. 7-11 show an example of a thread with posts contributed by registered users on a website page according to a preferred embodiment of the present invention.

FIG. 12 shows an example of a website registration page according to the present invention.

FIG. 13 shows an example of an abridged version of a thread (corresponding to the thread of FIGS. 7-11) printed on a magazine page according to the present invention.

FIG. 14 shows an example of a product advertisement related to a thread printed on a magazine page, according to the present invention.

FIG. 15 shows an example of a magazine table of contents according to the present invention.

FIG. 16 shows an example of a website survey printed in a magazine according to the present invention.

FIG. 17 is a diagram of a simplified structure for a website according to the present invention.

FIGS. 18-23 show an example of a thread with posts contributed by registered users of an online forum, where the thread and posts relate to dental case presentations.

### DETAILED DESCRIPTION

Recently, a wide range of interactive devices has been developed to provide information to a variety of users via communications networks. These interactive devices include, for example, computers connected to various computer on-line services, interactive kiosks, interactive television systems, a variety of other wired and wireless devices, such as personal data assistants (PDA's), and the like. In particular, the popularity of computer on-line services has grown immensely over the last decade. Computer on-line services are provided by a wide variety of different companies.

In general, most computer on-line services are accessed via the Internet. The Internet is a global network of computers. One popular part of the Internet is the World Wide Web, or the “Web.” The World Wide Web contains computers that display graphical and textual information. Computers that provide information on the World Wide Web are typically called “Web sites.” A Web site is defined by an Internet address that has an associated electronic page, often called a “home page.” Generally, a home page is an electronic document that organizes the presentation of text, graphical images, audio and video into a desired display. These Web sites are operated by a wide variety of entities, which are typically called “providers.”

A user may access the Internet via a dedicated high-speed line or by using a personal computer (PC) equipped with a conventional modem, or a variety of other wired and wireless devices. Special interface software, called “browser” software, is installed within the PC or other access device. When the user wishes to access the Internet by normal telephone line, an attached modem is automatically instructed to dial the telephone number associated with the local Internet host server. The user can then access information at any address accessible over the Internet. Two well-known web browsers, for example, are the Netscape Navigator browser marketed by Netscape Communications Corporation and the Internet Explorer browser marketed by Microsoft Corporation.

Information exchanged over the Internet is typically encoded in HyperText Mark-up Language (HTML) format. The HTML format is a scripting language that is used to generate the home pages for different content providers. In this setting, a content provider is an individual or company that places information (content) on the Internet so that others can access it. As is well known in the art, the HTML format is a set of conventions for marking different portions of a document so that each portion appears in a distinctive format. For example, the HTML format identifies or “tags” portions of a document to identify different categories of text (e.g., the title, header, body text, etc.). When a web browser accesses an HTML document, the web browser reads the embedded tags in the document so it appears formatted in the specified manner.

An HTML document can also include hyperlinks, which allow a user to move from one document to another document on the Internet. A hyperlink is an underlined or otherwise emphasized portion of text that, when selected using an input device such as a mouse, activates a software connection module that allows the user to jump between documents or pages (i.e., within the same Web site or to other Web sites). Hyperlinks are well known in the art, and have been sometimes referred to as anchors. The act of selecting the hyperlink is often referred to as “clicking on” the hyperlink.

When reading this specification, the following information may assist in understanding terms and acronyms:

Client-Server. A model of interaction in a distributed system in which a program at one site sends a request to a program at another site and waits for a response. The requesting program is called the “client,” and the program, which responds to the request, is called the “server.” In the context of the World Wide Web, the client is typically a “Web browser”, which runs on a user's computer; the program which responds to Web browser requests at a Web site is commonly referred to as a “Web server.”

Domain Name System (DNS). An Internet service that translates domain names (which are alphabetic identifiers) into IP addresses (which are numeric identifiers for machines on a TCP/IP network).

Internet. A collection of interconnected (public and/or private) networks that are linked together by a set of standard protocols to form a distributed network. While this term is intended to refer to what is now commonly known as the Internet, it is also intended to encompass variations, which may be made in the future, including changes and additions to existing standard protocols.

HyperText Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

HyperText Transport Protocol (HTTP). The standard World Wide Web client-server protocol used for the exchange of information (such as HTML documents, and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

LAN (Local Area Network)—This term is sometimes used herein to refer to a system that links together electronic office equipment, such as computers and word processors, and forms a network within an office or building.

PDA (Personal Digital Assistant)—This term is sometimes used herein to refer to a small hand held computer with or without wireless access to the Internet. A lightweight, hand-held, usually pen-based computer used as a personal organizer.

Transmission Control Protocol/Internet Protocol (TCP/IP). A standard Internet protocol (or set of protocols) that specifies how two computers exchange data over the Internet. TCP/IP handles issues such as packetization, packet addressing, handshaking and error correction. For more information on TCP/IP, see Volumes I, II and III of Corner and Stevens, Internetworking with TCP/IP, Prentice Hall, Inc., ISBNs 0-13-468505-9 (vol. I), 0-13-125527-4 (vol. II), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and if none is entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN (Wide Area Network)—This term is sometimes used herein to refer to a communications network that uses such devices as telephone lines, satellite dishes, or radio waves to span a larger geographic area than can be covered by a LAN. World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the HyperText Transfer Protocol (HTTP), and the electronic pages are encoded using the HyperText Markup Language (HTML). However, the terms “World Wide Web” and “Web” are intended to encompass future markup languages and transport protocols that may be used in place of or in addition to the HyperText Markup Language and the HyperText Transfer Protocol.

Print (printed, printing). These terms are used herein to refer to physically printed matter (such as, for example, in a magazine or book, etc.) and exclude electronic publication (such as, for example Internet web pages, digital media, etc.).

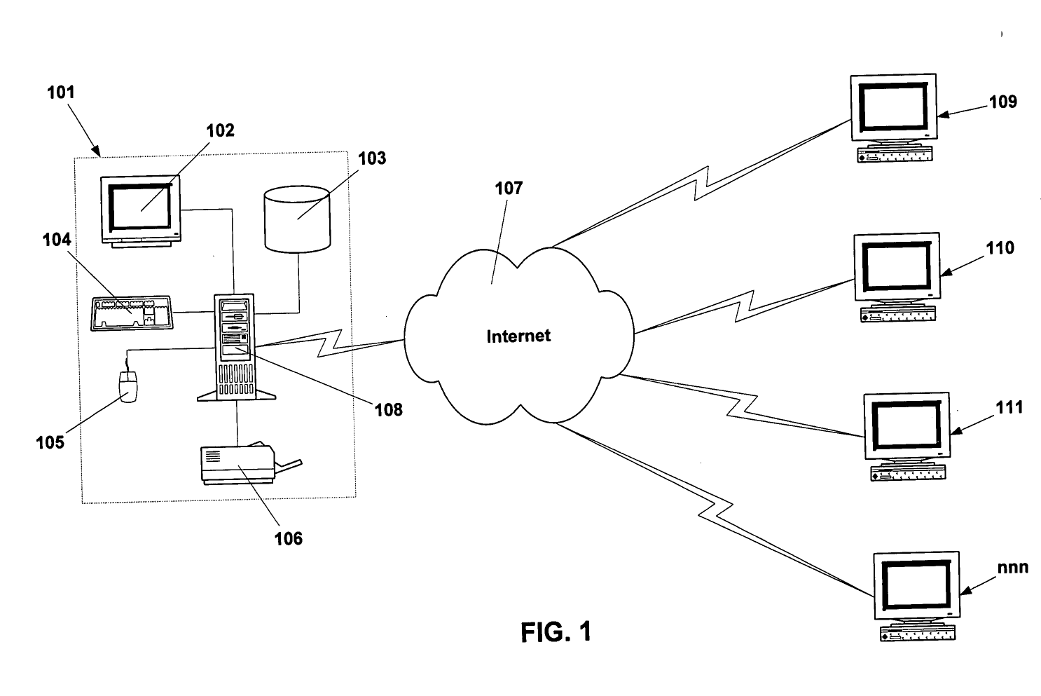

FIG. 1 illustrates a preferred computer network system for practicing the present invention. The system includes a web server 101. The web server 101 includes input and output devices, as is well known in the art. For example, the web server 101 preferably includes a display screen or monitor 102, a keyboard 104, a mouse 105, a printer 106, etc. The web server 101 further includes a database 103 for storage of the data and software included in preferred embodiments of the present invention. The web server 101 also includes a server computer 108 for processing the data and software. The web server 101 is connected to a network 107, which serves as a communications medium with users 109, 110, 111 and nnn (where nnn refers to any number of users). In presently preferred embodiments of the invention, the network 107 comprises the Interntet. The Internet, as previously discussed, comprises a global network of networks and computers, public and private. Upon reading this specification, those skilled in the art will now understand that, under appropriate circumstances, considering issues such as developments in computer hardware, software and connectivity, etc., other network configurations and devices also may suffice, such as for example, PDAs connected via a wireless network, etc.

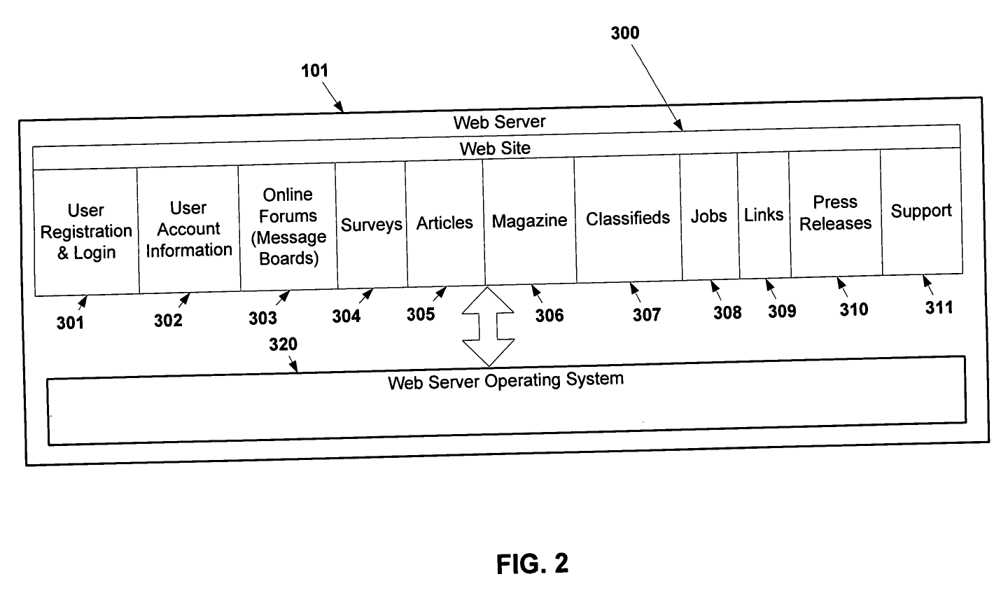

FIG. 2 shows the web server 101 configured according to a preferred embodiment of the invention. The web server 101 hosts website 300, which includes a module for user registration and login 301, a module for user account information 302, a module for message boards (also called an online forum 303), a module for surveys 304, a module for articles 305, a module for an online version of a magazine 306, a module for classified advertising 307, a module for job listings 308, a module for links 309, a module for press releases 310 and a module for support 311. Upon reading this specification, those skilled in the art will understand that, under appropriate circumstances, considering issues such as user preference, services offered by website manager, market demand, subject area, etc., other functional modules may be included, such as for example, a continuing education module for professionals such as dentists, etc.

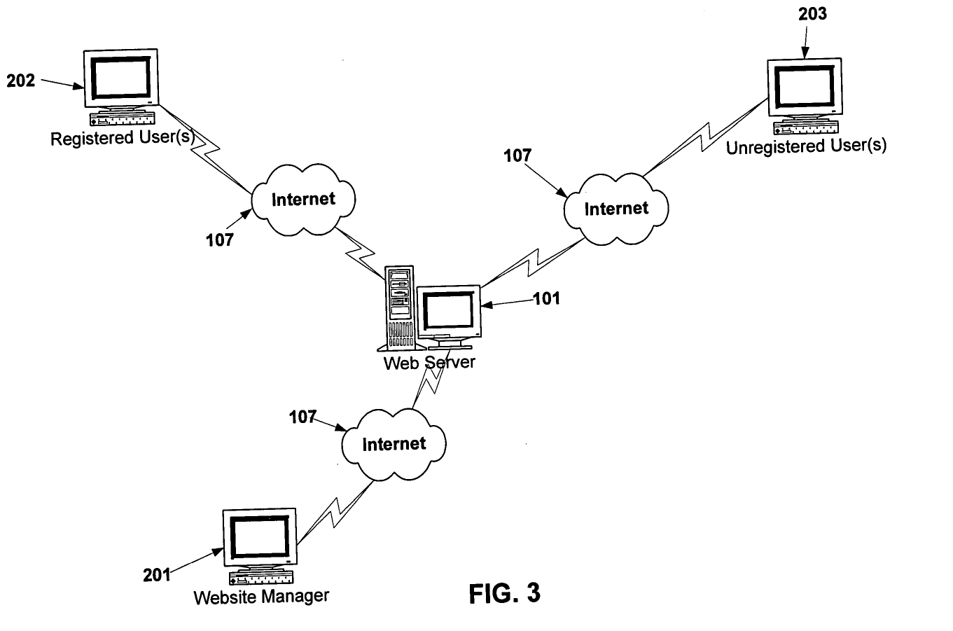

FIG. 3 is a diagram showing the relationships between a registered user 202 (exemplary of any number of users 109, 110, 111, nnn), an unregistered user 203 (also exemplary of any number of users), the Internet 107, the web server 101 hosting website 300 (see FIG. 2), and a forum manager 201, all according to a presently preferred embodiment of the invention. A registered user 202 connected via the Internet 107 can read and contribute content to the online forum 303 hosted on the web server 101. An unregistered user 203 connected via the Internet 107 can access the module for user registration and login 301 to the website 300.

Preferred software for an embodiment of the present invention comprises the following software and technologies: Microsoft NT Server 4.0, Internet Information Server 4.0, Microsoft Site Server, Commerce Edition, v3.0, SQL Server 7.0; Message Board software: Infopop's UBB.Classic v6.0, and ActiveState ActivePerl v5.6; Persits ASPUpload v3.0, Persits ASPJpeg v1.2; Technologies used: Active Server Pages (ASP), Component Object Model (COM). In a preferred embodiment, Infopop's UBB message board software is modified as follows: UBB's built in registration module is bypassed and integrated into a site-wide custom registration module, a portion of UBB's built-in edit account module is disabled in favor of a site-wide edit account module, and UBB member profiles are modified to include avatars.

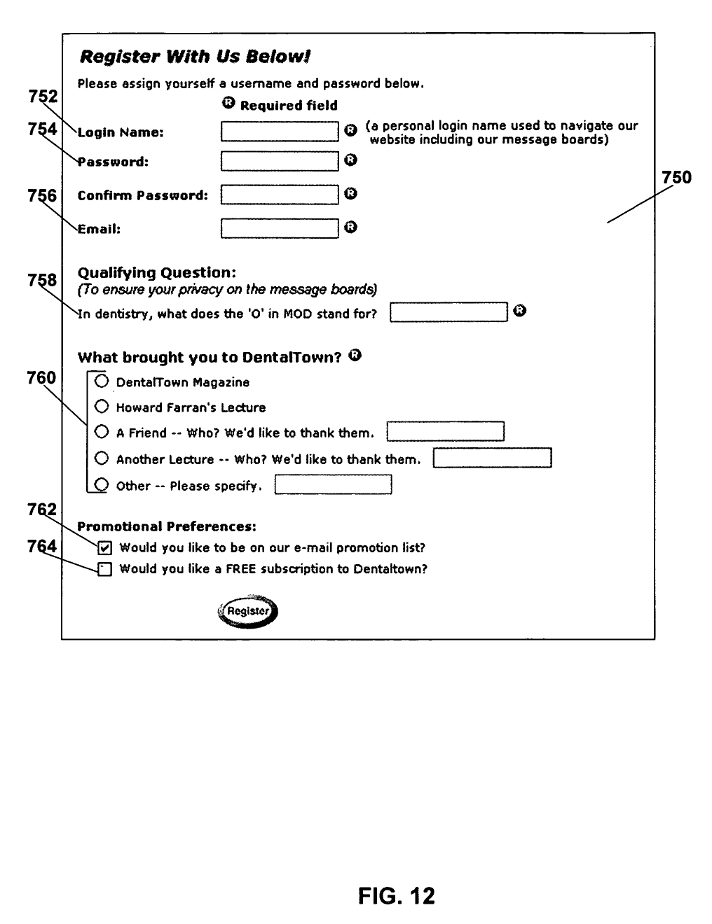

Referring again to FIGS. 2 and 3, the unregistered user 203 interested in accessing and/or interactively contributing content to the website 300 must first gain access through user registration and login 301 to the website 300. Preferably, the unregistered user 203 must demonstrate qualification in such subject area in order to become a registered user 202. In one such embodiment, as a requirement for registration, an unregistered user 203 applying to register must demonstrate some minimum level of knowledge in such subject area, such as by correctly answering at least one qualifying question about the subject area. For example, in an embodiment involving the subject area of dentistry, registration can be substantially restricted to dentists and others knowledgeable in dentistry, and as a requirement for registration, an unregistered user 203 applying to register must answer at least one qualifying question 758 about dentistry correctly (see FIG. 12).

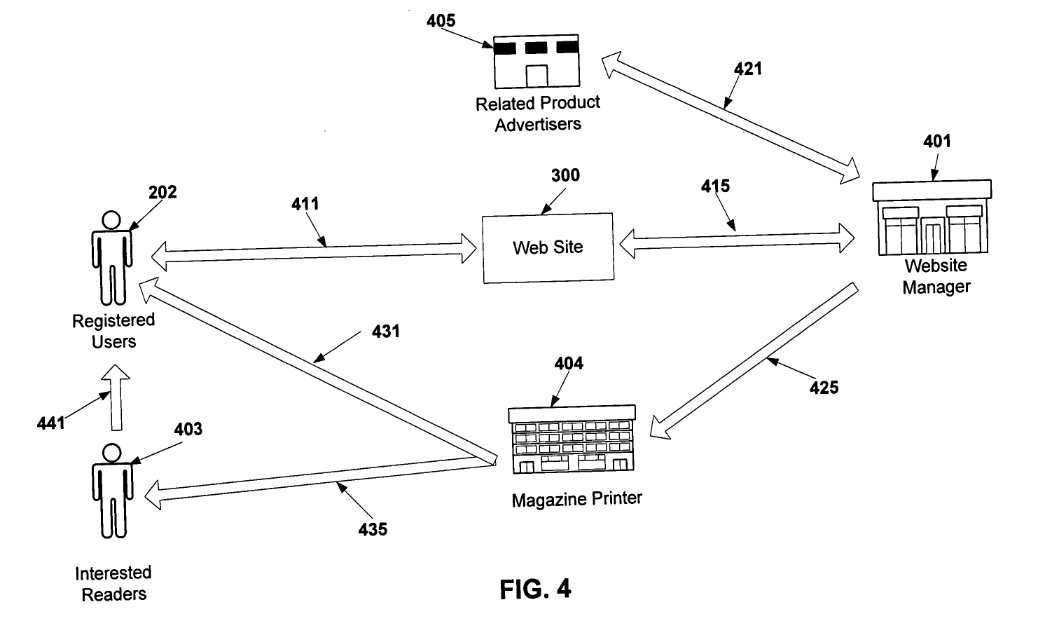

As a requirement for registration, an unregistered user 203 also must agree that any content contributed by the unregistered user 203 to website 300 may published and/or printed by a website manager 401 and/or magazine printer 404 (see FIG. 4). In addition, the unregistered user 203 must agree that any intellectual property rights to content contributed by the unregistered user 203 to the website 300 are assigned to the website manager 401. Preferably, if an unregistered user 203 attempting to register does not meet the above requirements, the unregistered user 203 cannot complete the registration process and become a registered user 202 and therefore cannot gain access to the online forum 303. Thus, the website 300 restricts participation in the online forum to entities that agree to assign any intellectual property rights for any content contributed to the online forum by such entities and that agree that the website manager and/or magazine printer may publish and/or print such content. Upon reading this specification, those skilled in the art will understand that, under appropriate circumstances, considering issues such as the type of vertical market being served, the distribution of entities, hardware and software being used, etc., other methods of restricting access to the website 300 also may suffice, such as for example, registration providing tiered access, access restriction based on a private intranet, etc. Preferably, however, to promote participation by entities qualified in the subject area there is no fee for such an entity to become a registered user 202, and access to the website 300 is provided substantially free to registered users 202.

Appendix A presents an example user agreement, according to a preferred embodiment of the present invention. Preferably, an unregistered user 203 must consent to such an agreement before being allowed to become a registered user 202 and before gaining access to the online forum 303.

Print media and online media each have advantages and disadvantages over the other. A preferred embodiment of the present invention succeeds in obtaining for print media some of the advantages of online media. Despite the growing popularity of online media content, many people still prefer to read print media (such as magazines and books, etc.). Print media can still reach a much wider distribution of entities in some vertical markets than a website or other internet/online media. For many people, the effort involved in going to a computer and looking up a website address is more than picking up a magazine received in the mail. People who are not especially computer savvy often prefer the familiar and easy manipulation of flipping pages compared to scrolling and clicking through websites. Others don't like the glare of a computer display screen. For these people, print media has advantages. PDAs and new small wireless Internet devices allow more portability for electronic media. Despite this, however, when it comes to portability, ease of reading, and convenience, print media remains more popular than electronic media (especially since such wireless Internet devices have not yet permeated, much less saturated, most vertical markets). These are some of the many reasons why print media are more popular and effective for many professional journals compared to online publishing. However, as mentioned before, one of the disadvantages of traditional print media is that since it is less convenient for readers to give feedback to the printer, printers tend to be more “out of touch” with what the readership thinks and wants to read about.

FIG. 4 is a simplified functional diagram of a preferred embodiment according to the invention showing the relationships between product advertisers 405, the website manager 401, the website 300, a magazine printer 404, magazine readers 403 and registered users 202. As shown in FIG. 4, the magazine printer 404 prints and distributes magazines to interested readers 403, as indicated by flow 435, and to registered users 202, as indicated by flow 431. Preferably, the interested readers 403 comprise a substantial portion of a vertical market including entities having interest in a common subject area. In one exemplary embodiment, the vertical market is the vertical market of dentistry and related dental products and services. Preferably, magazines are provided substantially free to qualified entities of the vertical market in the subject area. Again referring to the exemplary embodiment for the vertical market for dentistry and related dental products and services, the magazine printer 404 prints and distributes a dentistry magazine to interested readers 403 including dentists other qualified entities in the field of dentistry.

Typically a subset of interested readers 403 (and perhaps also additional people who do not receive the printed publication) qualified in the subject area will also be interested in accessing and interactively contributing content about the subject area via website 300 and will become registered users 202 as indicated by flow 441. Registered users 202 receive information and contribute to the website 300 as indicated by flow 411. Preferably, website 300 provides a relatively open, informal, and unbiased forum for registered users 202 to encourage participation and contributions. For example, dentists can create threads on the online forum 303, posting questions or raising issues to get feedback and opinions from other dentists about products and procedures. A dentist, for example, may want feedback from other dentists about the advantages and disadvantages of packing cord versus an alternative retraction system. Although it is beneficial to know what 4 out of 5 dentists prefer, it is more statistically relevant and beneficial to know what 40 out of 50 dentists prefer and to get their opinions in their own words, with comments. Preferably, the website manager 401 receives information and contributes to the website 300 as indicated by flow 415. For example, the website manager 401 may post articles, polls, and questionnaires, or raise issues open for comment by registered users 202. The website manager 401 can select popular threads and topics from website 300 and edits such threads to produce abbreviated versions for printed publication. The magazine printer 404 also can cooperate with the website manager 401, which provides the website 300 with the online forum 303 in the subject area.

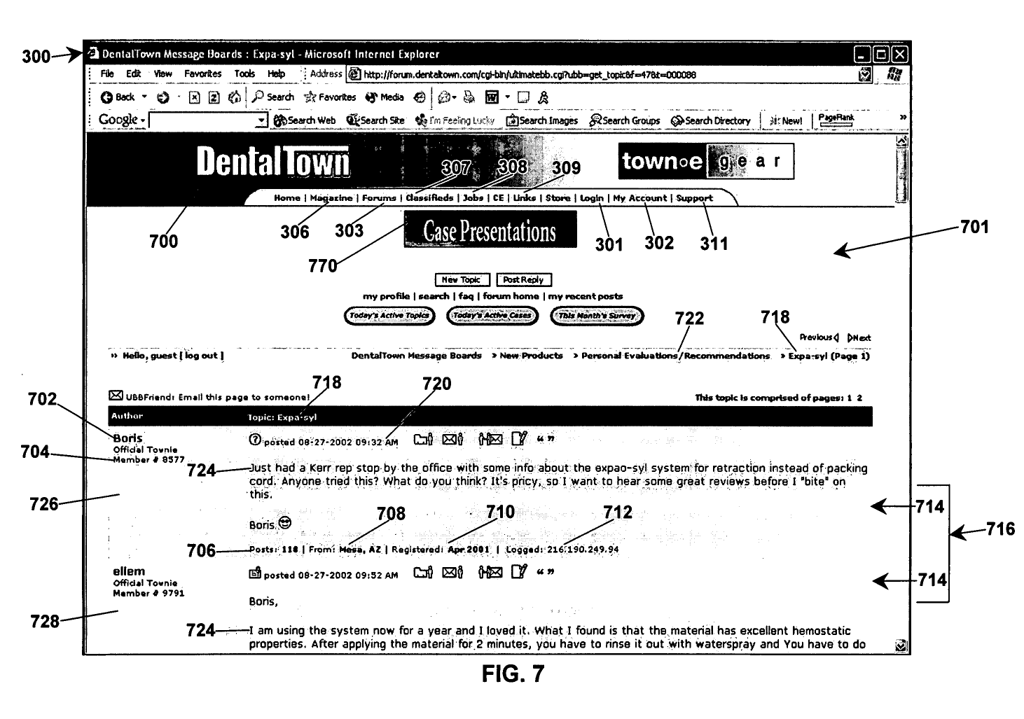

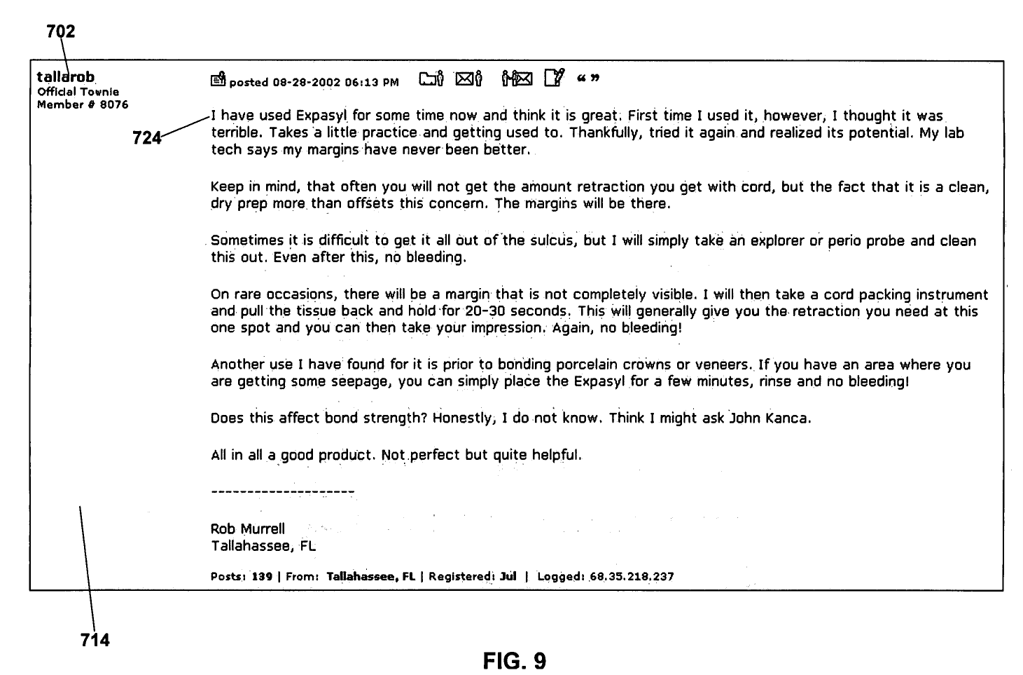

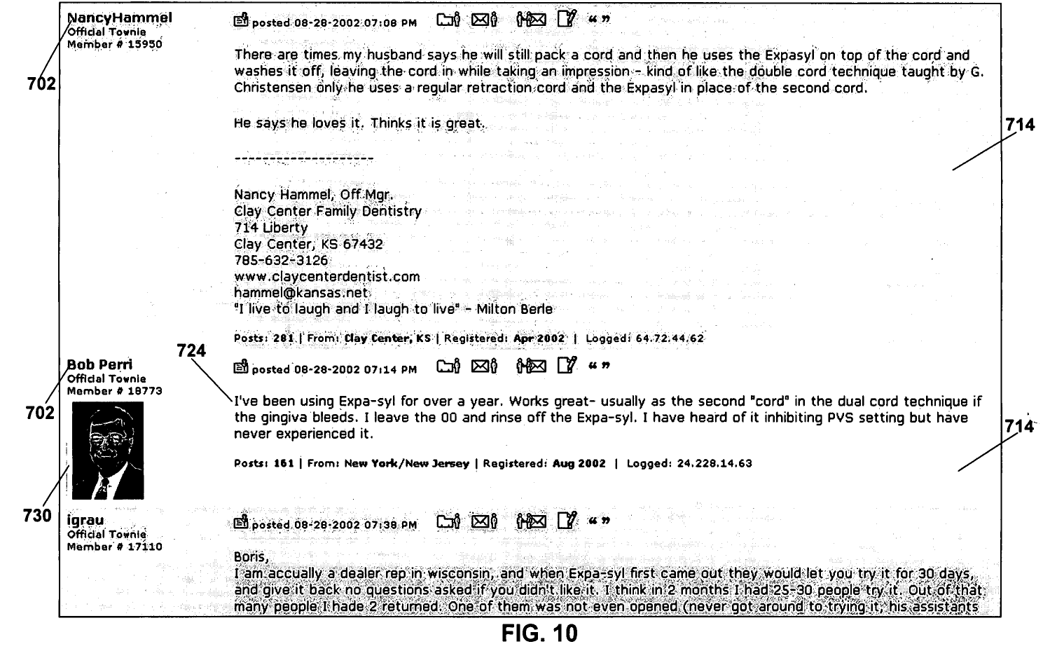

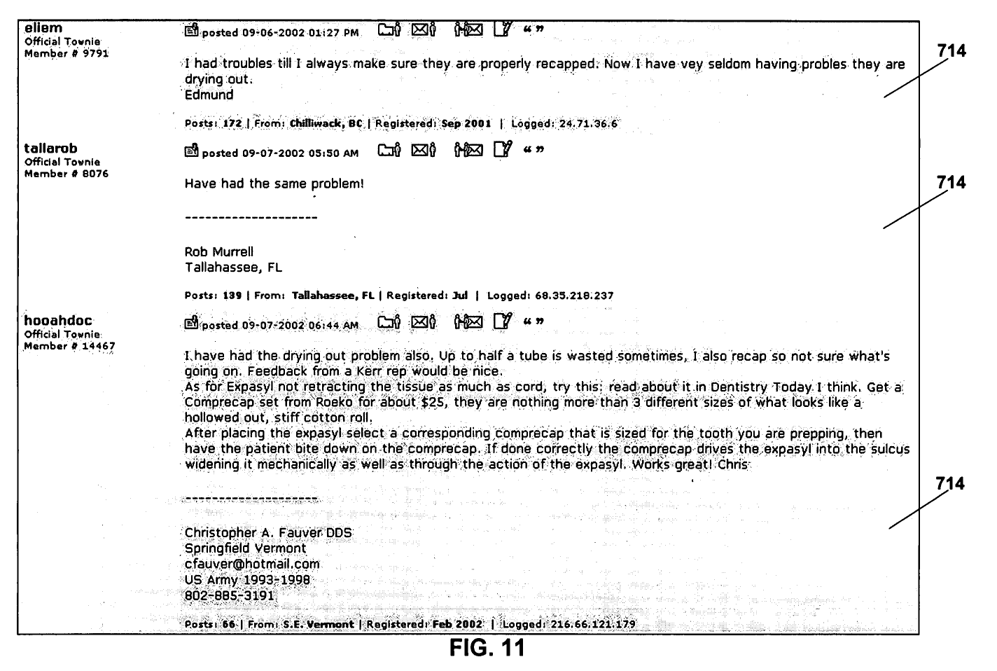

Preferably, registered users 202 can access the online forum 303 (see FIG. 2) at any time (24 hours a day). The online forum 303 allows registered users to post comments 724 (see FIGS. 7-11) and responses to other registered users and to conveniently interact. The online forum 303 allows registered users 202 to create threads about topics in which they are interested, which allow them to share ideas, ask questions, voice concerns, discuss techniques, and find solutions, etc. The online forum 303 tracks thread data, such as the contributor of each post, the time of each post, the total number of posts in each thread, etc. Preferably, the online forum 303 is substantially devoid of advertising to provide a more attractive forum for users and to help avoid the appearance of bias.

The online forum 303 provides the magazine printer 404 with feedback about which topics most interest the readers and further provides the magazine printer 404 with relevant topical content in the subject area. By evaluating which threads are the most popular, as indicated by factors such as number of total posts in the thread, number of contributors to the thread, number of users that have read the thread, etc., the magazine printer 404 can select threads/topics in which magazine readers will most likely be interested, especially since registered users 202 (although typically a minority of those receiving the magazine) provide a relatively large representative sample of interested readers 403. The online forum 303 also provides a way for the magazine printer 404 to tap the collective experience and knowledge of registered users 202 because registered users 202 can easily and conveniently contribute their opinions, suggestions, and solutions to various problems or ideas in the subject area. For example, a collection of dentists that have encountered rare or fairly unique problems can provide multiple perspectives on such issues. Even for common issues, the breadth of experience provided by the relatively large group of participating users can provide benefits that a single contributor, such as a professional writer in the subject, often cannot provide.

The website manager 401 can contact product advertisers 405 selling products related to popular threads in order to sell advertising space for products related to the popular threads/topics. A preferred criterion for selecting which threads/topics are “popular” (and therefore should be selected for printed publication) is the number of registered users posting to a thread. An alternate preferred criterion for selecting which threads are “popular” and therefore should be selected for printed publication is the total number of posts in a thread. The website manager 401 can sell advertising to product advertisers 405, as shown by flow 421, and can arrange with the magazine printer 404, to print such advertising, preferably adjacent the associated thread in the printed publication, for distribution to interested reader 403 and registered users 202, as shown by flow 425.

The inventor has discovered that many interested readers 403 are enticed to become registered users 202 by the perception that there is much less effort required to get their opinions printed in a magazine published as described in this specification (especially when such entities may present their ideas and contributions informally). This includes those interested readers who would like to contribute their opinions and insights in the subject area but typically would not make the effort to contribute material to a printed publication because of the perceived high level of effort involved to have something published (by a traditional trade journal, for example).

Many entities in a subject area, including interested readers 403 and registered users 202, desire to receive recognition for the knowledge and expertise they have developed in the subject area. Many entities in the subject area, including interested readers 403 and registered users 202, also desire to contribute their knowledge for the greater good and benefit of others. The website 300 provides a way for such entities to easily and conveniently contribute their ideas and knowledge, and to receive the wide distribution and recognition that a printed publication offers. For many such entities, seeing their own contributions in a printed magazine is a much greater and more prestigious honor than just having their contributions posted on a website. Thus, such entities have even greater incentive to become registered users and contribute content to the website 300, as indicated by flow 441, since such contributions may be selected to be printed by the magazine printer 404. Further, interested readers 403 who desire to receive further information about the subject area and who access from the website 300 the unabridged version of threads printed in the magazine are also motivated to become registered users 202.

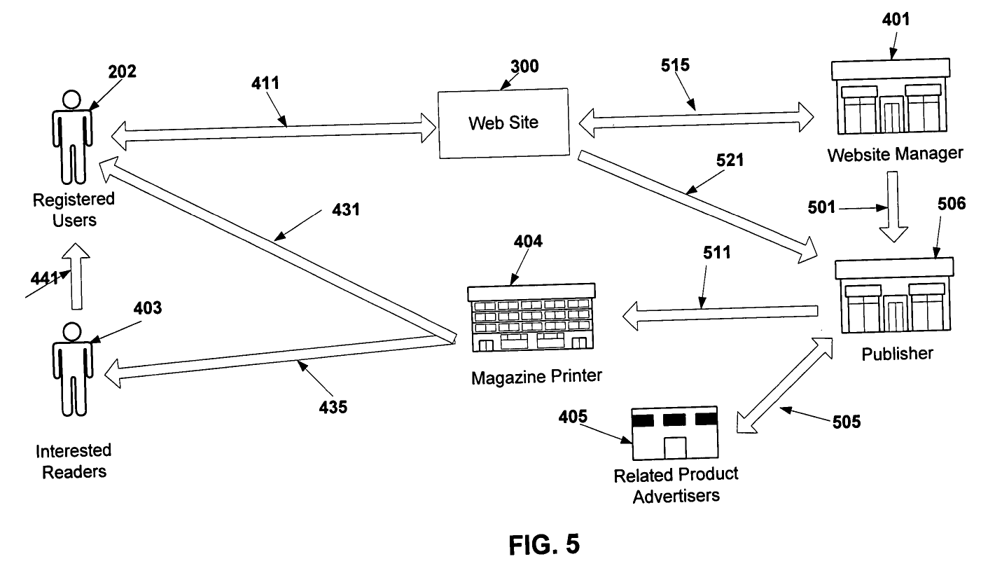

FIG. 5 depicts an alternate preferred embodiment of the present invention, showing relationships between and among interested readers 403, registered users 202, a publisher 506, the magazine printer 404, the website 300, the website manager 401 and related product advertisers 405. As shown in FIG. 5, the website manager 401 receives information and contributes to the website 300 as indicated by flow 515. The publisher 506 can collect information from the website manager 401, such as, for example, demographic information about registered users 202, as shown by flow 501. The publisher 506 also can collect information from the website 300, as indicated by flow 521, regarding threads and topics from the website 300 that are popular with registered users 202. Preferably, the publisher 506 selects popular threads and topics from the website 300 and edits such threads to produce abbreviated versions for printed publication which are then distributed to interested readers 403 and registered users 202, as discussed above. The publisher 506 can contact product advertisers 405 who desire to sell or are selling products related to popular threads in order to sell advertising space for products related to the popular threads/topics. Also, the publisher 506 can sell advertising to product advertisers 405, as shown by flow 505, and can arrange with the magazine printer 404, as shown by flow 511, to print such advertising, preferably adjacent the associated thread in the printed publication.

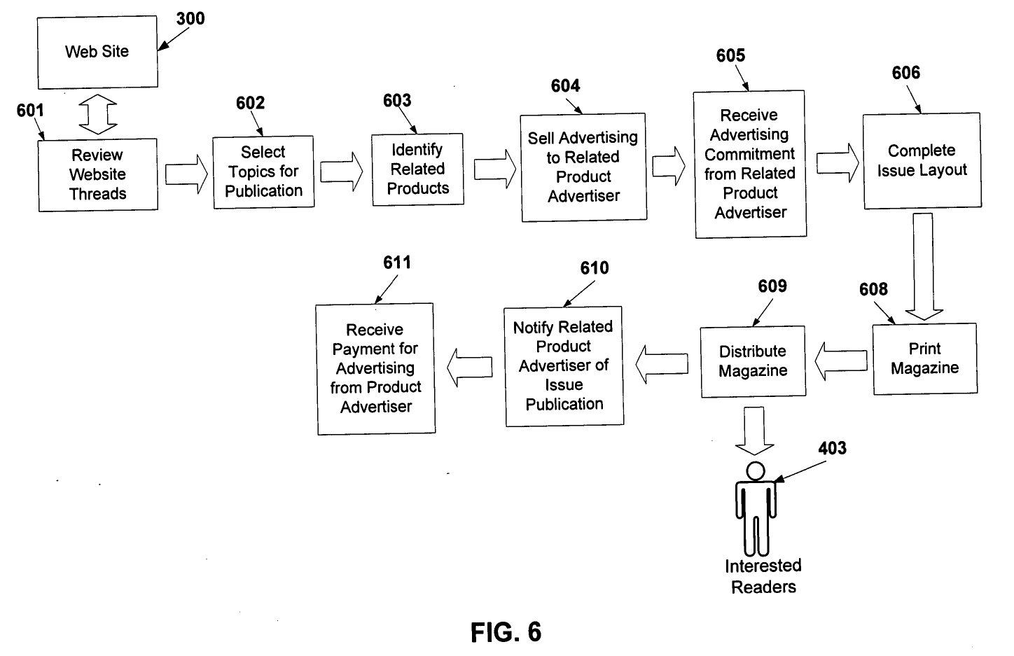

According to one preferred aspect of the present invention (as an improved way of generating advertising revenue, among other advantages) information from the online forum 303 can be used to select topics for publication in the print magazine, to sell advertising for the magazine and to publish the magazine. With particular reference to FIG. 6, the magazine printer 404 preferably has access to the website 300. The magazine printer 404 can review the recent online message board postings/website threads (step 601) on the website 300. Then the magazine printer 404 (step 602) can select topics for publication from among such postings/threads. The magazine printer 404 can then identify related products and/or services that may have an association with one or more of such selected topics (step 603). After that, the magazine printer 404 is in an improved business position to sell advertising in the magazine to related-product advertisers (see step 604) and will preferably offer space in the printed magazine to such advertisers adjacent the associated topic in the printed magazine. Upon reading this specification, those skilled in the art will understand that, under appropriate circumstances, such as having various kinds of demographic information about posting and/or reading entities from the website and/or other sources, such selling practices might include various communications relevant to, for example, such demographics.

After the selling step 604, the magazine printer 404 ideally will receive one or more advertising commitments from the related-product advertisers (step 605). After all topics and products/services have been selected/identified and such sales consummated, magazine printer 404 can complete the magazine layout for the current issue to be published (see step 606). Such layout will preferably take advantage of the controllable sizes and locations of the message board postings on the selected topics to generate maximum advertising revenue with minimal loss of readability interest. Typically, for the exemplary dentists' magazine, about 4-5 spaced published threads comprise such “maximum/minimum”. Then magazine printer 404 can print (step 608) and distribute (step 609) the magazine to interested readers 403. The magazine printer 404 can notify the related-product advertisers of the issue publication (step 610). Then the magazine printer 404 will ideally receive payment for the advertising from the related-product advertisers (step 611). Upon reading this specification, those skilled in the art will understand that, under appropriate circumstances advertising revenue might be secured or paid to magazine printer 404 in various ways, for example, partially or wholly prepaid, or may include business trades or discounts or special offers, etc. The magazine printer 404 may deal with various advertising buyers not all of whom are related-product/service advertisers but at least some of whom may be advertising agencies, industry groups, or others wishing to place and pay for advertising, etc.

FIG. 12 shows an example of a website registration page 750 according to a preferred embodiment of the present invention. The website registration page 750 includes fields for entering registration data such as a login name (also called screen name 752), a password 754, and contact information such as an email address 756. The website registration page 750 also has at least one field that asks the user to answer a qualifying question 758, to demonstrate qualification in the subject area of the website before being able to become a registered user 202 and to access online forum 303.

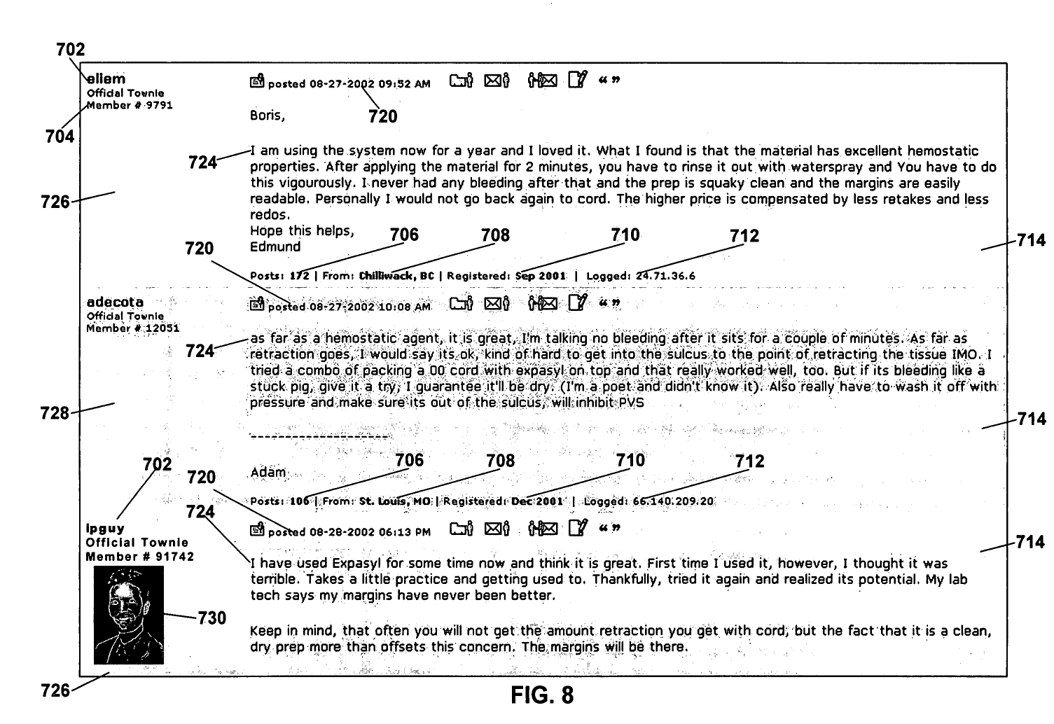

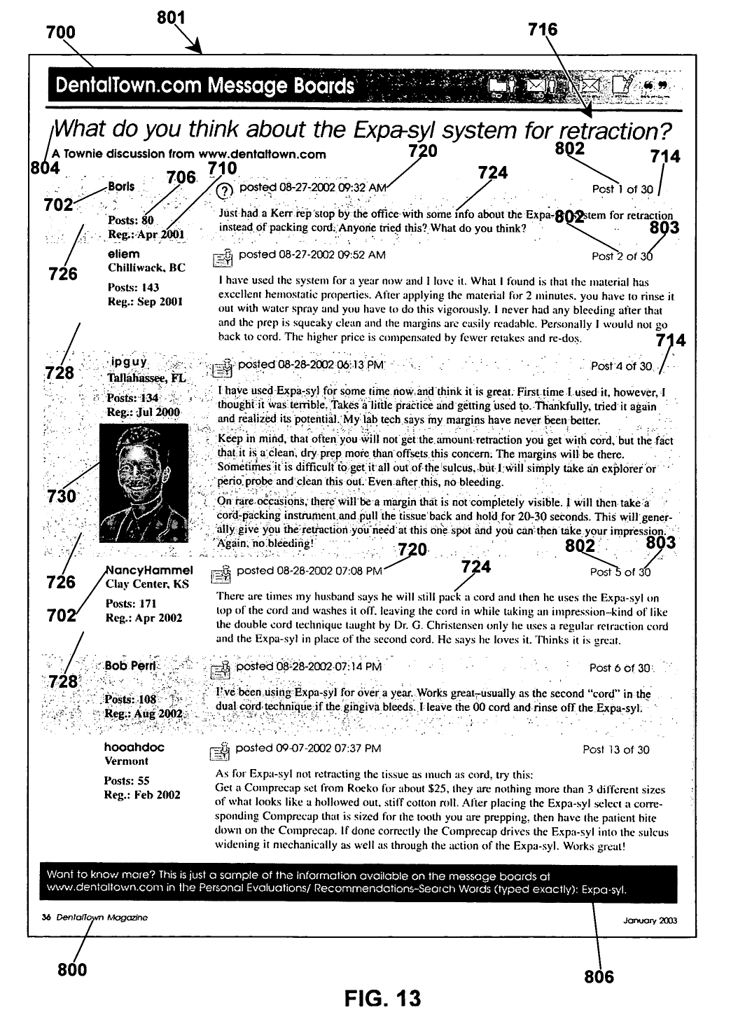

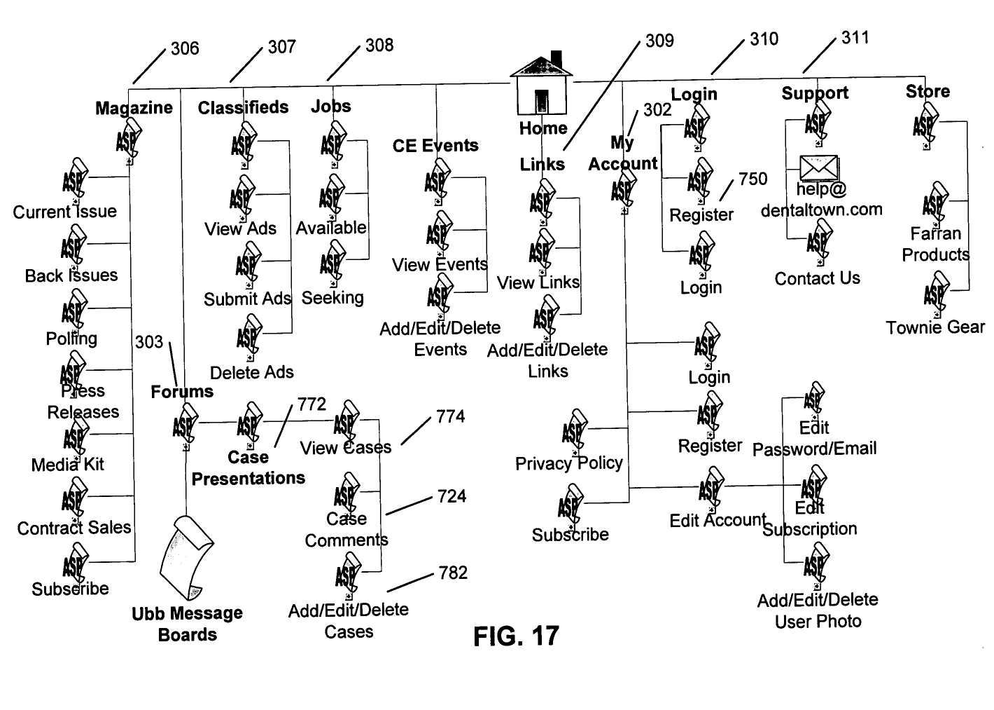

FIGS. 7-11 show an example of a thread with posts contributed by registered users on a website page according to a preferred embodiment and method of the invention. Referring to FIGS. 7-11, a thread 716 with posts 714 includes comments 724 contributed by registered users 202 on a forum thread page 701 of the website 300. Preferably, the forum thread page 701 includes website branding 700 identical to magazine branding 800 (see FIG. 13). Forum thread page 701, as well as other pages of the website 300, can have hyperlinks allowing registered users 202 to easily navigate between different pages and modules of the website 300 as shown by FIG. 17. Such hyperlinks can include hyperlinks for the online version of the magazine 306, forums 303, classifieds 307, jobs 308, links 309, login and registration 301, user account information 302, technical support 311, and other pages such as continuing education, home page, online store, etc., as shown in FIGS. 7-11 and 17. The website 300 utilizes message board software, well known by those familiar in the art, that organizes and categorizes the thread 716 by a topic category 722 according to well known methods. The forum thread page 701 includes a thread title 718, which allows users to quickly identify the topic and subject matter of the thread 716. Posts 714 of the thread 716 are displayed in chronological order on the forum thread page 701. Consecutive posts 714 of the thread 716 can have alternating background shades (dark background 726 and light background 728) so that registered users 202 can more easily distinguish where one post ends and the next post begins. Upon reading this specification, those skilled in the art will understand that, under appropriate circumstances, considering issues such as the number of posts, number of contributors, etc., other means for differentiating one post from another may suffice, such as for example, assigning a unique background color to each contributor, etc. The post 714 includes a screen name 702 and other user information about the contributing registered user 202, such as a member number 704, total number of contributor posts 706, a contributor location 708, a contributor registration date 710, a contributor IP address 712 and/or a contributor picture 730 (see FIG. 8).

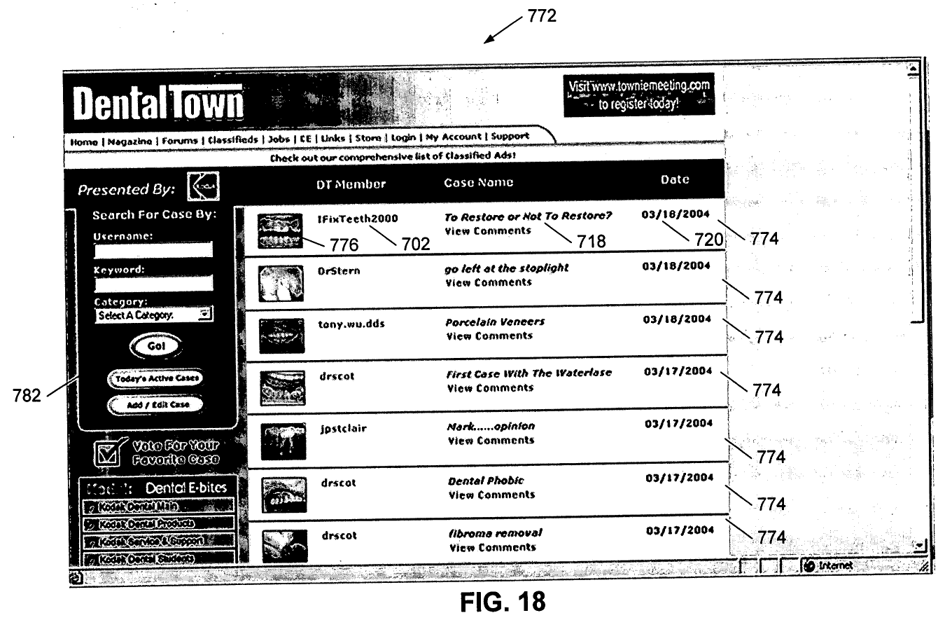

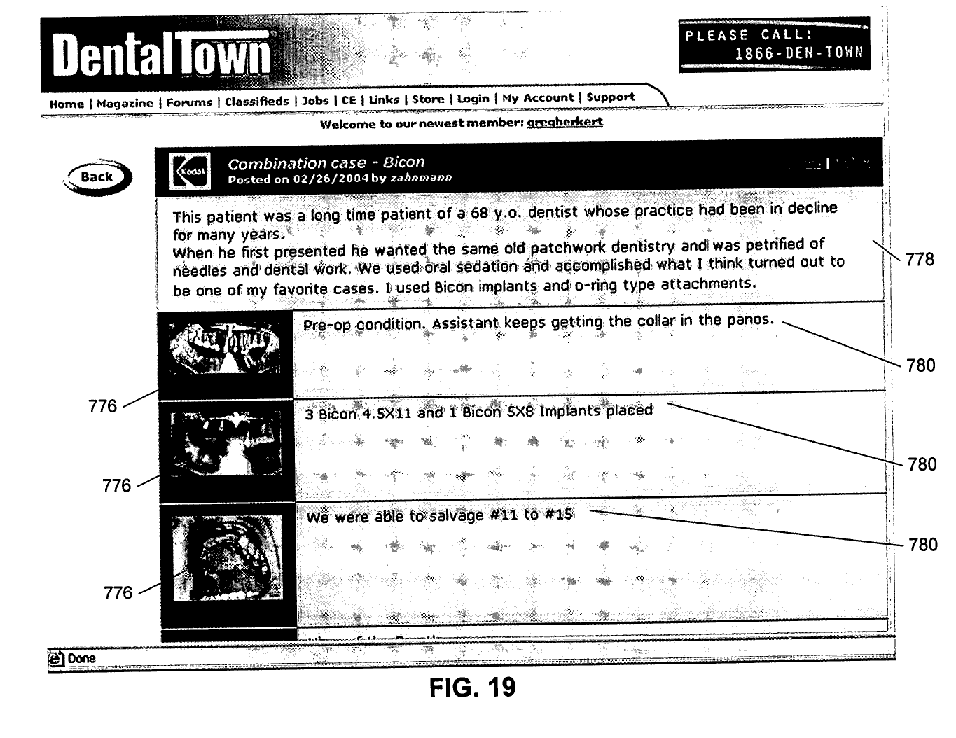

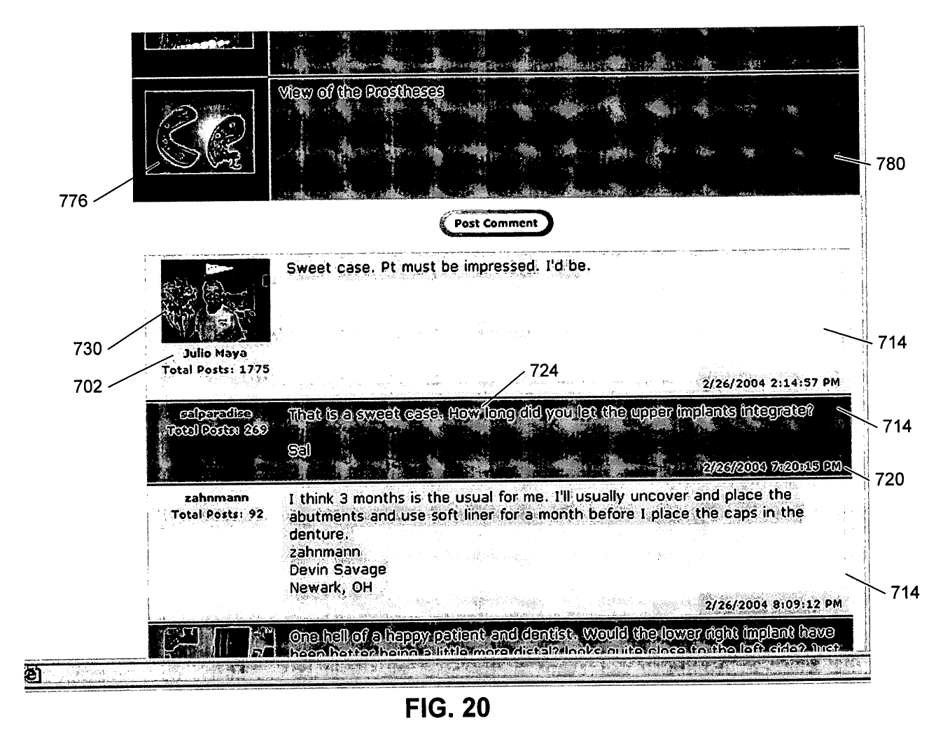

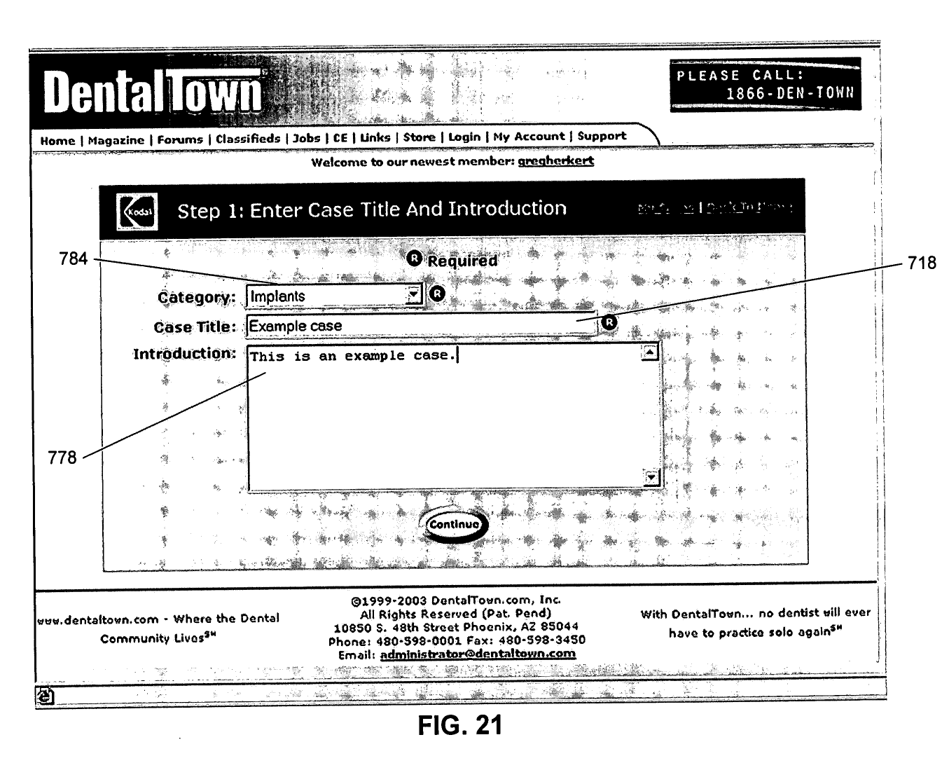

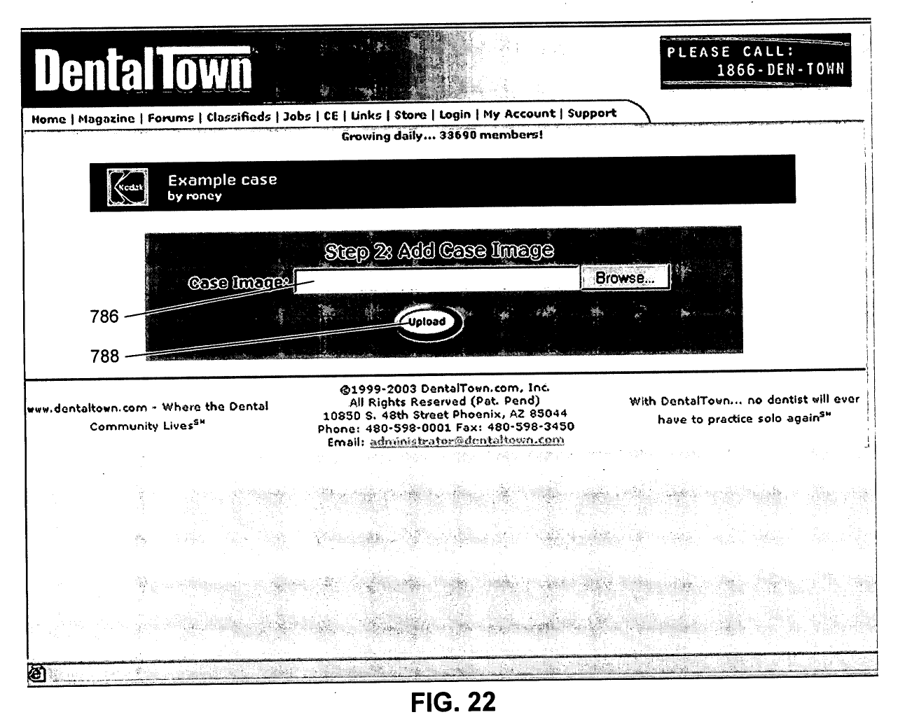

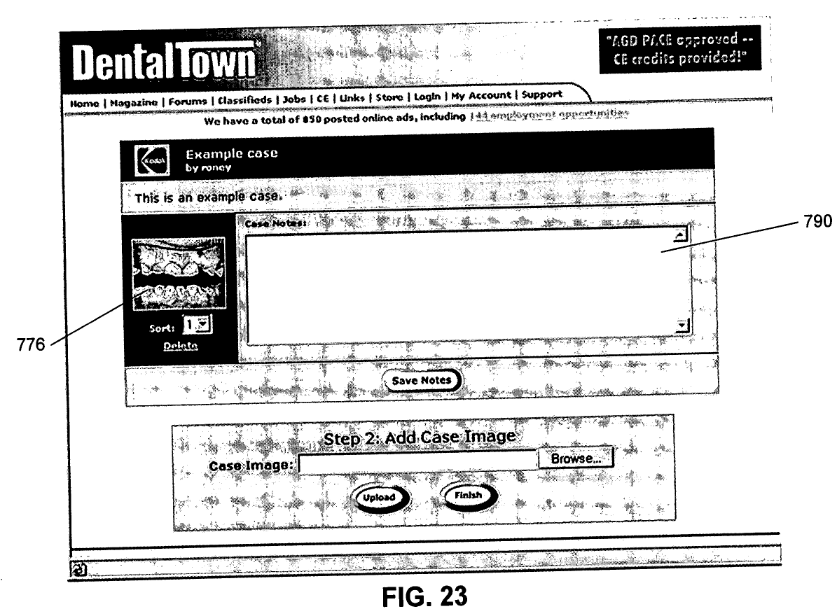

FIGS. 18-22 show an example of a thread with posts contributed by registered users of an online forum, where the thread and posts relate to dental case studies and utilize images related to the case studies. A registered user 202 can select a case presentations hyperlink 770 (see FIG. 7) to access a case presentations page 772. The case presentations page 772 displays posted case presentations 774, which include information such as the screen name 702 of the contributing registered user 202, the case name (i.e., the online thread title 718 for the case), the date of the post 720, and an image 776 representative of the case. When the registered user 202 selects a posted case presentation 774 to view, introductory information 778 is displayed along with images 776 posted for the case and case notes 780 for the images. Posts 714 of content contributed by other registered users 202, including comments 724, are also displayed. A registered user 202 also can select a link 782 to add or edit a case presentation. The registered user 202 enters a case presentation by entering a case category 784 from a menu of case categories, a case name/online thread title 718. The registered user 202 also has the option of entering the introduction 778 to the case. In addition, the registered user 202 can add an image 776 to a case presentation by entering the path for the image 776 in a case image field 786 and selecting an upload button 788 to upload the image to the website 300. The image 776 is then displayed for the registered user 202 to enter case notes 780 in a case note field 790.

FIG. 13 shows an example of an abridged version of a thread (corresponding to the thread of FIGS. 7-11) printed on a magazine page according to a preferred embodiment of the present invention. Preferably, at least one page 801 of the printed magazine includes portions of a thread 716 selected from the online forum 303. The magazine page 801 is printed in a format recognizably similar to the thread 716 in online forum 303 to assist interested readers 403 in understanding and appreciating that the content is from the online forum 303. This recognizably similar format can include alternating background shades (dark background 726 and light background 728) so that interested readers 403 can more easily distinguish where one post ends and the next post begins. Preferably, the recognizably similar format can include the screen name 702 and other user information about the contributing registered user 202, the total number of contributor posts 706, the contributor location 708, the contributor registration date 710 and/or the contributor picture 730 (see FIG. 8). It is noted that the recognizably similar format items such as screen name 702, total number of contributor posts 706, etc., are items that are not printed in a typical magazine article and help interested readers 403 to differentiate such content as originating from a website thread 716. Preferably, posts of thread 716 are printed in chronological order and include the time of post 720 for each post 714. Preferably, the printed version of thread 716 is condensed and edited by publisher 506 or magazine printer 404. The printed version of thread 716 on magazine page 801 can provide an indication of which posts have been omitted, for example, by showing the original post number 802 and the total number of original posts 803 from website 300. Therefore, as shown in the example of FIG. 13, interested readers 403 can see that “post 3” has been omitted in the printed version, since the printed version goes from “post 2 of 30” to “post 4 of 30” as indicated by the original post number 802 and the total number of original posts 803 for the second and third posts 714 on the magazine page 801.

Preferably the online forum 303 allows registered users 202 to interact and respond multiple times with posts 714 to a thread 716. This opportunity for multiple responses is a vast improvement over the limitation afforded by a letter to the editor of a typical magazine or publication, since often it takes more than one iteration to reach a solution or provide answers to counter-arguments, etc.

The thread 716 printed on the magazine page 801 includes a thread title 804 that preferably indicates the essence of the subject matter and content of posts 714 within the thread 716. It is noted that the magazine printer 404 or publisher 506 may edit or rewrite the thread title 718 from the original online forum 303 to create a different thread title 804 for the magazine page 801 (especially since the online thread title 718 is typically created with the first online post and cannot fully anticipate the direction of the discussion that will follow, whereas the magazine printer 404 or publisher 506 can create an appropriate thread title 804 with the benefit of hindsight). Registered users 202 can include content pictures in the comment 724 portion of the post 714. For example, the best way for a dentist to communicate a problem or issue, and get feedback on a case study, may be to post actual photos of the patient's condition, as described more fully above. It is noted that comment pictures are typically related to the subject of the thread while the contributor picture 730 (also known as an avatar) is typically a picture of the contributor.

Preferably, the thread 716 printed in the magazine includes at least three posts 714 to give multiple perspectives on the topic and/or show responses and counter-responses. Printing at least three posts 714 of thread 716 also helps interested readers in recognizing the content as being from the online forum 303.

Preferably, the magazine page 801 includes the online thread location 806, which indicates that the unabridged version of the thread 716 is available online and how to locate the thread on the online forum 303. Preferably the magazine branding 800 (for example, “DentalTown”® (magazine) and website branding 700 (for example “DentalTown.com”) are identical, or nearly identical. Upon reading this specification, those skilled in the art will now understand that, under appropriate circumstances, considering issues such as brand name recognition, corporate structure, relationship of publishing and website management entities, etc., other branding options may be used.

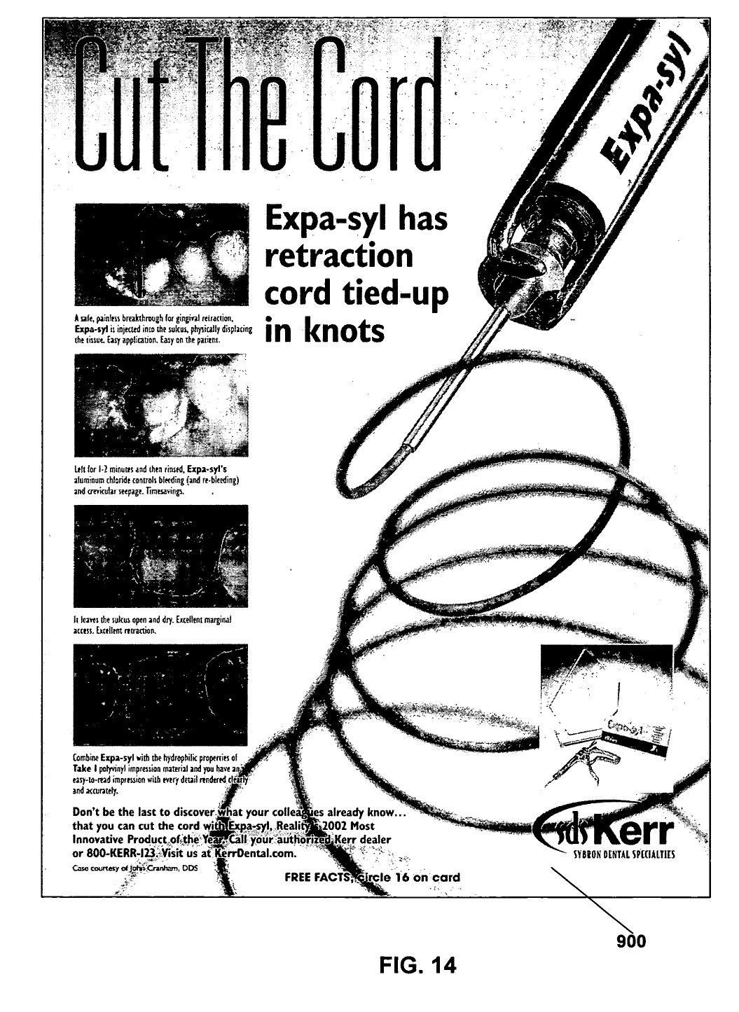

FIG. 14 shows an example of a product advertisement related to a thread printed on a magazine page. Preferably, the advertisement 900 is for a product or service, etc., related to the subject matter and comments of the thread 716. The advertisement 900 is printed in the magazine adjacent to the corresponding thread that discusses the product, service or related subject matter in order to provide maximum impact for the advertiser. For example, FIG. 13 shows a thread 716 which discusses “the Expa-syl system” printed on page 36 of the magazine and FIG. 14 shows an advertisement, for “the Expa-syl system”, which is printed on the (adjacent facing) page 37 of the magazine.

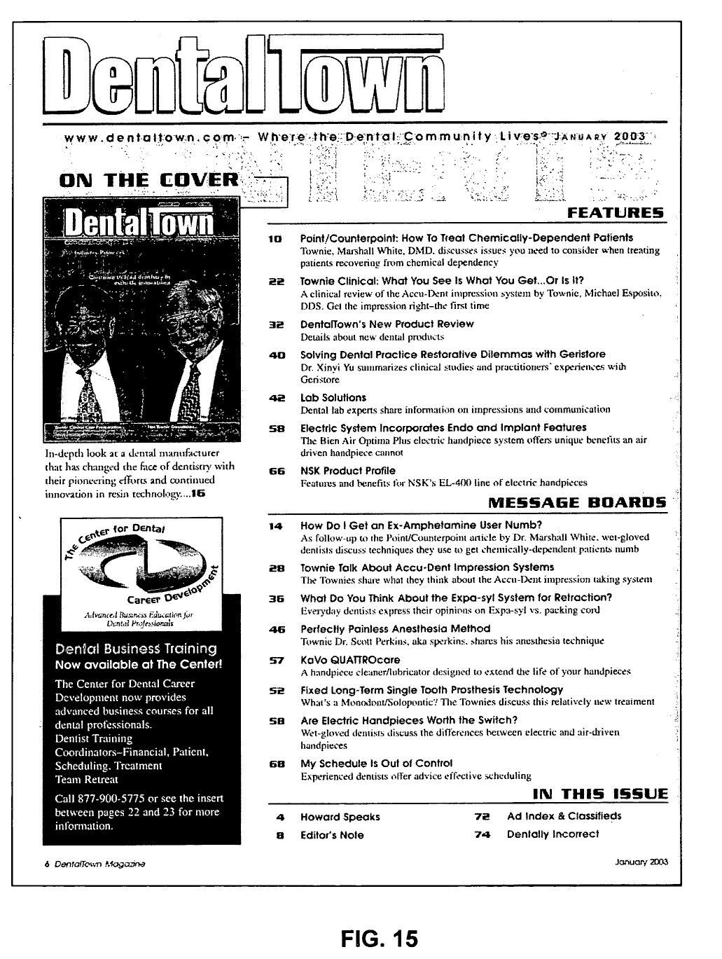

FIG. 15 shows an example of the table of contents of a magazine published according to a preferred embodiment and method of the present invention. As shown in FIG. 15, at least one thread from the online forum 303 is selected for printing in the magazine on a controversial topic judged from the responses by registered users 202. For example, DentalTown® magazine features a monthly feature called “point/counterpoint” which features posts from registered users 202 that have opposing viewpoints on a subject.

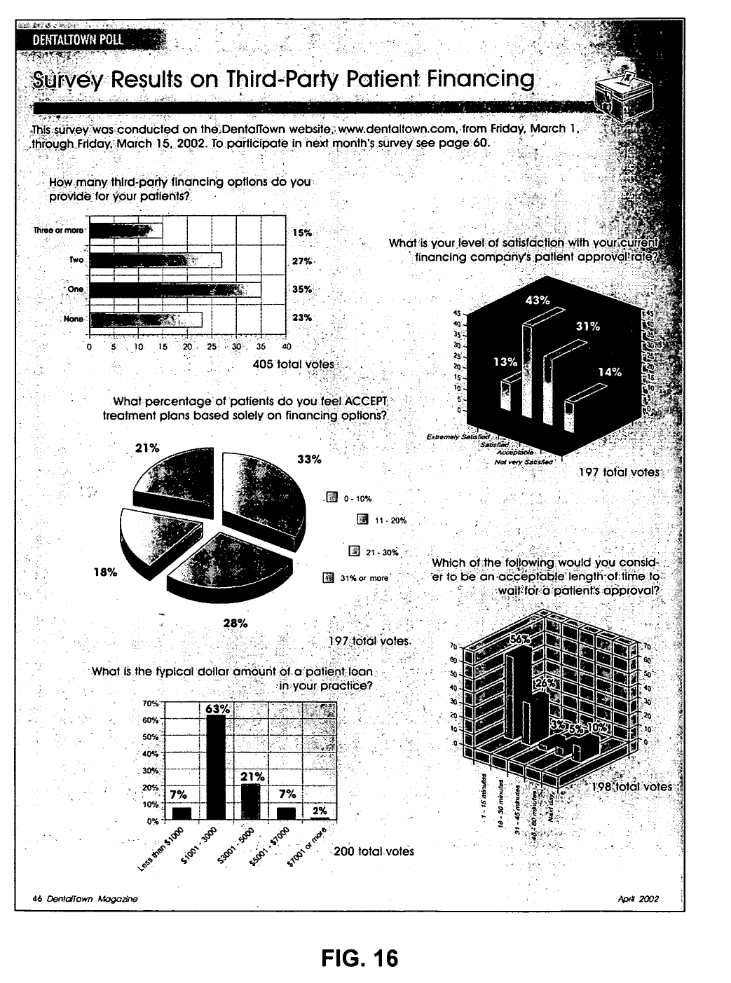

FIG. 16 shows an example of a website survey printed in a magazine published according to a preferred embodiment and method of the present invention. As shown in FIG. 16, the website 300 can provide surveys and polls that allow registered users 202 to see the “votes” of the registered users 202 on different topics. Demographic data can be collected from registered users 202 who participate in online polls to provide survey results that can include demographic and other information about those polled (such as credentials and other qualifications of those being polled). Preferably, results from the online poll are printed in the associated magazine.

The online forum 303 also provides a valuable and marketable resource for the website manager 401 to generate additional revenue and/or provide additional services to registered users 202 via online polls and surveys. The website manager 401 can utilize the participation of the registered users 202 to provide additional services to product advertisers 405, such as surveys and polls customized to meet the needs and requirements of such product advertisers 405. For example, product advertisers 405 can easily and conveniently get feedback about their products from registered users 202. Such registered users 202 are likely to be highly correlated with the appropriate group targeted by the product advertisers 405 in the subject area. The subject matter and phrasing of surveys and polls can be determined by the website manager 401. Upon reading this specification, those skilled in the art will understand that, under appropriate circumstances, considering issues such as business model, revenue streams, subject area, etc., other entities (such as for example, registered users, or independent third parties) may select the subject matter and phrasing for polls and surveys. Product advertisers 405 can contract with the website manager 401 to conduct a survey, which website manager can then post on the website 300 and/or e-mail to registered users 202. Upon reading this specification, those skilled in the art will now understand that, under appropriate circumstances, considering issues such as business model, etc., other methods of providing surveys and polls may be used.

Preferably, the website 300 periodically provides awards for products and services, etc. in the subject area, based upon the voting of registered users 202. Awards add value and recognition to website branding and magazine branding. Further, since awards are based upon the voting of the registered users 202, registered users 202 and interested readers 403 put more trust and faith in the legitimacy of such awards, and such awards are therefore more valuable. Product advertisers 405 that receive awards are likely to reference the awards in their advertising, giving more exposure to the website branding and magazine branding. Also, product advertisers 405 that receive awards are more likely to place ads in the magazine, thus generating more revenue for the magazine printer 404 or publisher 506.

APPENDIX B shows exemplary portions of an issue of a printed magazine that has been published according to the present invention.

From the foregoing, it can be seen that the present invention possesses numerous advantages. It provides an apparatus and method for creating a printed publication with input and content from a substantial portion of the readership of the printed publication, by which it is easy and convenient for interested readers to provide content and feedback for the printed publication. The invention provides incentives for interested readers to contribute content to such the printed publication. It allows a publisher to select and print content that will be very likely to interest the readership. It does all of this in an efficient, inexpensive and handy manner.

Additional advantages and modifications will readily occur to those skilled in the art. Therefore, although applicant has described applicant's preferred embodiments of this invention, it will be understood that the invention in its broader aspects is not limited to the specific embodiments, details, representative devices, and illustrative examples shown and described. Accordingly, departures may be made from such details without departing from the spirit or scope of the general inventive concept. Such scope is limited only by the below claims as read in connection with the specification.

### APPENDIX A

### Agreement Between User And Dentaltown.Com

These terms of use are an agreement between DentalTown.com, Inc. (“DentalTown.com”) and users of its website (“you” or “user”). This agreement (the “Agreement”) also governs your use of the products and services made available to you by DentalTown.com through its website (the “Website”). By clicking on the button below marked “I Accept” or using the Website, you acknowledge that you have reviewed and agree to all of the provisions, disclosures and disclaimers in this Agreement and agree to be bound by them in connection with your use of the Website. DentalTown.com reserves the right to modify or supplement any or all of the terms of this Agreement from time to time without notice to you. DentalTown.com reserves the right, in its sole discretion, to restrict, suspend or terminate access to all or any part of the Website or to change, suspend or discontinue all or any aspect of the Website, including the availability of any feature, database, information or content, at any time and without prior notice or liability.

As you use the Website, you will encounter windows and hyperlinks that take you to web pages or websites of other companies with which we contract, either to make their products and services available to you or to enable you to communicate directly with those companies. Your use of such web pages or websites, while subject to the terms of this Agreement, is also subject to and governed by the terms and guidelines, if any, contained within such web page or website. Where such web page or website contains terms, conditions, policies, notices or disclaimers prepared by DentalTown.com related to the use of our Website or other web pages, or websites accessed through our Website, such terms, conditions, policies, notices or disclaimers are incorporated by reference into this Agreement whether or not any such term, condition, policy, notice, or disclaimer is referenced below. You acknowledge that you are aware of and accept the terms and conditions of DentalTown.com's Privacy Policy.

### Emergency Medical Conditions Do not use this Site for Medical Emergency Services. In an Emergency, Call 911 or your Local Emergency Assistance Number. Restricted to Adults

You must be at least 18 years of age to use DentalTown.com. You agree to be solely responsible for (i) maintaining such controls over the use and/or access to DentalTown.com by minors in your family or (ii) having access to your computer or login limited to the extent necessary to restrict use to adults.

### Our Staff

Our staff includes, in part, dentists and other health care professionals. None of our dentists will enter into a dentist-patient relationship with you, and no other Professional participants will establish any clinical relationship with you while they are using DentalTown.com's services. They can assist you in your personal, general research but they will not engage in any conduct that involves the practice of medicine or other health care profession. The information you obtain from the Website should not substitute for or be used instead of a clinical or therapeutic relationship with a health care professional. You are responsible for reviewing and understanding all research and other information obtained by you from the Website.

The Professional participants will not create or retain any medical records about you or monitor your care. The Professional participants should not be considered to be your treating or care giving health care professional and will not communicate with your own health care provider. Consequently, any information you obtain from the Website should not substitute or be used instead of a relationship with a health care professional. All users are encouraged to seek the advice of, and regularly consult with, dentists and other health care professionals of their selection. You should not disregard or delay medical advise or treatment based on information on the Website.

DentalTown.com does not clinically evaluate or perform credentialing of the Professional participants, because the Professional participants are not practicing medicine or providing medical advice, prescriptions or opinions about individual-specific treatment matters. Thus, our internal policy that each dentist of the Professional participants be “Board Certified” or “Board eligible” is solely for our benefit, and may be changed or waived at any time. The Professional participants do not diagnose or treat any medical conditions or prescribe medication or treatments for anyone using the DentalTown.com Website. The Professional participants should not accept payment from you and should not bill any insurance company, government payment program, or other source of health benefits in compensation for providing information to you on the Website. If you decide to seek information or obtain treatment from any Sponsor (as described below), the Professional participants will not follow up or monitor your care.

Please do not share personal medical information of a kind you would wish to be held confidential in a dentist-patient or similar clinical relationship. The members of the Professional participants do not keep any medical records and will not have any records concerning prior contacts you may have made to our Website. Since the dentists on the Professional participants are not in a dentist-patient relationship with you, the information you provide will not be considered a medical record. DentalTown.com shall have the right to use any questions, comments, or other information submitted by users in books, articles, commentaries, research or similar ways.

When we receive an e-mail, we make reasonable efforts to respond in as timely a manner as possible but DentalTown.com does not guarantee that it will respond to all inquiries. We reserve the right to ignore or delete any information including, without limitation, information that is fraudulent, abusive, defamatory, obscene or in violation of a copyright, trademark or other intellectual property or ownership right of any other person. You should be aware of the general risks of transmitting information over the Internet. While DentalTown.com attempts to prevent unauthorized persons from accessing our files or tampering with our site, we cannot guarantee that these efforts will always be successful or that information will be transmitted without interruption or error.

### Our Sponsors

DentalTown.com is one way for you to gather general medical information and to make contact with certain clinics or hospitals or other contracting sponsors in your area who have arranged to post advertisements on, and make other information available through, our Website (the “Sponsors”). Our relationships with a Sponsor in a particular area are based on factors we establish, which may include offering exclusivity in a particular region. Sponsor information may be displayed based on the zip code where you reside. All information regarding a specific Sponsor has been provided by that Sponsor.

We contract with Sponsors for a fee and such fee is not based on the volume or value of any services Sponsors may or may not provide to our users. We do not endorse, credential or accredit the services our Sponsors advertise and make no representations or warranties about the type of services, quality of care, source of payment or billing practices of our Sponsors. We do not verify or update the licenses, accreditations, certifications or other permits and approvals of any Sponsor. You are responsible for all activities between you and a Sponsor.

If you indicate that you wish information about or from a Sponsor, or to be contacted by a Sponsor, this information is passed along to the Sponsor. We also provide to our Sponsors general information about the users who contact our Website.

### Contacts With Others Websites

DentalTown.com may include or provide links on the Website to other web sites on the Internet, which may include information, opinions or recommendations of various individuals, organizations or companies. In providing such links, DentalTown.com does not represent to you that it has investigated the content of such information, opinions or recommendations, and thus you understand and agree that DentalTown.com does not warrant or guarantee the accuracy of such information or necessarily endorse, credential or accredit any such opinions, recommendations, websites, individuals, organizations or companies. You acknowledge and agree that DentalTown.com has no control over such sites and is not responsible for the availability of such external sites. You also acknowledge and agree that DentalTown.com does not endorse and is not responsible or liable for any content, advertising, products or other materials on or available from such sites. You should contact the site administrator or Webmaster for other websites if you have any concerns regarding such links or the content located on such other websites.

### Our Information

DentalTown.com strives to be a valuable resource of timely information for our users. We cannot ensure that information we provide is accurate, exhaustive or complete on every subject or that it will necessarily include all of the most recent information available on a particular topic. This information is of a general nature and we urge you to review it with your healthcare provider. Users should never delay, ignore or fail to obtain medical advice based on information obtained from DentalTown.com.

### Your Information

DentalTown.com may gather and share customer and client information with its Sponsors about the areas, topics and communities of interest, zip codes, and products and services identified, purchased or used by you and our other users of our Website. Such information may be aggregate or individual. Information we gather about the use of our website may be used, for example, in providing information to our Sponsors, advertisers or vendors of products and services with which we have a relationship. If you elect to provide additional information about yourself (which may include for example, your name, e-mail address, mailing address or other background or contact information), such information shall be used by DentalTown.com or any Sponsor for the purpose for which it was given. The manner in which we collect and use personally identifying information voluntarily provided by you is described in our Privacy Policy. Such information may also be used by DentalTown.com to enforce this Agreement.

### Research Organizations and Studies

We contract with research organizations, and other companies that recruit research candidates, that are interested in identifying individuals who may be interested in participating in research studies of various kinds. DentalTown.com is compensated under such arrangements. There are places on our Website that provide you with information about these research opportunities. Your decision to participate in a research study is completely voluntary. Any information you may provide to DentalTown.com in connection with requesting additional information on clinical trials may be disclosed to research organizations or similar entities, and therefore should not be considered confidential to DentalTown.com. You will not be compensated for providing such information to DentalTown.com, and you do not have any ownership in any research organization studies or anything derived from such studies. DentalTown.com does not evaluate, approve, review or endorse any research organization studies. We do not control or determine how information provided to a research organization is used by that organization or whether the research organization provides such information to others with which it has agreements.

### Copyright and Trademark

All text and images Copyright © [DATE] by DentalTown.com, Inc. The names “DENTALTOWN.COM”, and associated logos are proprietary trademarks and service marks of DentalTown.com, Inc.

The Website contains information, software, text, photographs, graphics and other material that are protected by copyright, trademark or other proprietary rights of DentalTown.com. All content on the Website is copyrighted as a collective work pursuant to applicable copyright law. You are granted a limited nonexclusive license to use the information for your personal and noncommercial use. Otherwise, you may not copy, store in electronics form, modify, print, transmit, sell or transfer, create derivative works from, distribute, perform, frame in another web page, display, or in any way exploit any of the content, in whole or in part. Permission to reprint or electronically reproduce any DentalTown.com materials is expressly prohibited without prior written consent from DentalTown.com. You may hyperlink to the Website provided that the link is to the “home” page of the Website.

The Website includes an interactive portion that allows users to submit information and materials. Users shall not provide copyrighted or other proprietary information to DentalTown.com without permission from the owner of such material or rights and shall be solely responsible for any damages resulting from such disclosures. Users shall be solely responsible for obtaining such permission and agree to indemnify DentalTown.com for any claim that information or materials submitted by you infringe any third-party intellectual property right. You grant DentalTown.com a nonexclusive license to use, copy, edit, modify, transmit, distribute and to create a derivative work of any information or material submitted by you through the Website, including but not limited to distribution in DentalTown.com's electronic and print newsletter.

If you believe that your work has been copied in a way that constitutes copyright infringement, please provide DentalTown.com's copyright agent the following information:

1. an electronic or physical signature of the person authorized to act on behalf of the owner of the copyright interest;

2. a description of the copyrighted work that you claim has been infringed;

3. a description of where the material that you claim is infringing is located on the site;

4. your address, telephone number, and email address;

5. a statement by you that you have a good faith belief that the dispute use is not authorized by the copyright owner, its agent, or the law;

6. a statement by you, made under penalty of perjury, that the above information in your Notice is accurate and that you are the copyright owner or authorized to act on the copyright owners behalf.

DentalTown.com's Copyright Agent for Notice of claims of copyright infringement can be reached at: By Mail: [MAIL ADDRESS] By telephone: [TELEPHONE NO.] By email: [EMAIL]

### Your Conduct

We may adopt and revise policies from time to time governing the conduct of our users, including, without limitation, when they exchange messages or information, participate in chat sites or community forums, which policies are incorporated by reference into this Agreement as noted above. We have the right, but not the obligation, to review, modify, block or delete any postings or messages we consider to be potentially defamatory, obscene, harassing, abusive, threatening or otherwise intended to or having the effect of interfering with or disrupting the exchange of information or operation of the Website. You agree not to use the Website or information from other users to send unsolicited commercial messages, or to initiate unsolicited commercial transactions, either individually or in a mass mailing or message distribution. If you post information, or other materials on the Website, you agree and represent and warrant that you have all rights under applicable law, including without limitation, copyright, trademark, trade secret, or other intellectual property laws, that permit you to provide this information on the Website and that we and all users have the right to download and use that information, software or other materials. You warrant to DentalTown.com that you will not use this Website for any purpose that is unlawful or prohibited by this Agreement of use in any manner.

### Use of Message Board

The Website includes a community message board. To access the message board, you will be required to select a user name and password. The user name that you select is the name that appears when you post on the message board. It can be any name that you select, as long as someone else has not selected that name before you. Your password, like your username, is only for logging into the communities. It can be anything you want it to be. If you are an AOL user, it does not have to be your AOL password, and in fact, we suggest that you not use your AOL password.

Considering the real-time nature of this message board, DentalTown.com cannot review messages or confirm the validity of information posted. DentalTown.com does not actively monitor the contents of posted messages, is not responsible for any messages posted, does not vouch for or warrant the accuracy, completeness or usefulness of any message, and is not responsible for the contents of any message. The messages express the views of the author of the message, not necessarily the views of DentalTown.com or any entity or individual associated with DentalTown.com. Any user who feels that a posted message is objectionable is encouraged to contact DentalTown.com immediately by email. If DentalTown.com determines that removal is necessary, it will make every effort to remove it within a reasonable time frame. Because removal is a manual process, removal or editing particular messages may not occur immediately.

You shall not upload, post or email any content or information that (a) is libelous, defamatory, obscene, pornographic, abusive, harassing or threatening, (b) contains viruses or other contaminating or destructive features, (c) violates the rights of others, such as content that infringes any copyright, trademark, patent, trade secret or violates any right of privacy or publicity, (d) offends the community standards of users of the Website (e) interferes with or disrupts the Website, (f) harass another user or (g) otherwise violates any applicable law. Although DentalTown.com does not and cannot review the messages posted and are not responsible for the content of any of these messages, it reserves the right to delete any message for any reason whatsoever. You remain solely responsible for the content of your messages, and you agree to indemnify and hold DentalTown.com harmless with respect to any claim based upon transmission of your message(s). DentalTown.com reserves the right to reveal your identity (or whatever information we know about you) in the event of a complaint or legal action arising from any message posted by you. DentalTown.com reserves the right to use any messages or information posted by you for any purpose, including but not limited reproduction in its electronic or printed publications and you grant DentalTown.com a nonexclusive license to use, copy, edit, modify, transmit, distribute and to create a derivative work of any such message or information.

### WARRANTY

INFORMATION SUPPLIED BY DENTALTOWN.COM IS PROVIDED “AS IS, AS AVAILABLE” AND NEITHER DENTALTOWN.COM NOR ANY OF THE PROFESSIONAL PARTICIPANTS, INCLUDING WITHOUT LIMITATION OUR DENTISTS AND SPONSORS, MAKE ANY REPRESENTATION OR WARRANTY WITH RESPECT TO THE CONTENTS OF THIS WEBSITE OR INFORMATION FURNISHED BY THEM OR OUR AGENTS, EMPLOYEES OR REPRESENTATIVES AND SPECIFICALLY DISCLAIM TO THE FULLEST EXTENT PERMITTED BY LAW ANY AND ALL WARRANTIES, EXPRESS OR IMPLIED, INCLUDING, BUT NOT LIMITED TO, IMPLIED WARRANTIES OF MERCHANTABILITY, COMPLETENESS, TIMELINESS, CORRECTNESS, NONINFRINGEMENT, OR FITNESS FOR ANY PARTICULAR USE, APPLICATION OR PURPOSE. YOU HEREBY ALSO AGREE THAT DENTALTOWN.COM, AND ITS SUBSIDIARIES, OFFICERS, DIRECTORS, AGENTS AND EMPLOYEES, SHALL NOT BE LIABLE TO YOU FOR ANY DAMAGES, CLAIMS, DEMANDS OR CAUSES OF ACTION, DIRECT OR INDIRECT, SPECIAL, INCIDENTAL, CONSEQUENTIAL OR PUNITIVE, AS A RESULT OF YOUR USE OF THIS WEBSITE OR ANY INFORMATION YOU OBTAIN ON IT OR ANY OTHER INTERACTION WITH DENTALTOWN.COM OR ITS SUBSIDIARIES. IN DOING SO, YOU AGREE THAT YOU ARE WAIVING VOLUNTARILY AND UNEQUIVOCALLY ANY LIABILITY OF DENTALTOWN.COM OR ITS SUBSIDIARIES.

DentalTown.com cannot make any representation or warranty concerning errors, omissions, delays or other defects in the information supplied to users, or that its files are free of viruses, worms, Trojan horses or other code that include or manifest contaminating or destructive characteristics.

### Indemnification

You agree to indemnify and hold harmless DentalTown.com, its affiliates and their respective officers directors, agents, and employees from and against any claim, demand, or cause of action, including any (including attorneys fees) arising out of claims based on any aspect of your use of the Website, including without limitation, (i) claims based on defamation or other conduct by you in using the Website, or (ii) your violation of any intellectual property laws including without limitation those relating to copyright, trademarks or trade secrets.

### Miscellaneous

If any clause or provision set forth herein is determined to be illegal, invalid or unenforceable under present or future law, then, in that event, you understand and agree that the clause or provision so determined to be illegal, invalid or unenforceable shall be severable without affecting the enforceability of all remaining clauses or provisions. The application of these provisions, disclosures, terms, conditions and disclaimers and all other matters arising from your use of this Website or of any information you obtain from DentalTown.com shall be governed by the laws of the United States of America and the State of Arizona. Any claims, disputes or other controversies relating to or arising from these provisions, disclosures and disclaimers or from your use of this Website or any information you receive from DentalTown.com shall be brought exclusively in the United States District Court, Arizona District, Maricopa Division or the Circuit Court for Maricopa County, Arizona, and you hereby expressly consent to the exercise of jurisdiction over you by such courts. To the fullest extent permitted by applicable law, each party to this Agreement waives its or his right to a jury trial with respect to any action brought under or in connection with this Agreement. Any notice to DentalTown.com shall be given in writing and sent by certified and registered mail to DentalTown.com, Inc., [ADDRESS], Attn: President: Howard Farran.

This Agreement constitutes your entire agreement with DentalTown.com and supersedes all prior or contemporaneous communications, proposals or agreements, whether oral or written, between us. You agree that this agreement takes effect on your first use of the Website, and that it applies to all persons accessing the Website from your computer. You agree and are obligated to regularly review this Agreement for changes and agree to those changes by continuing to use the Website. DentalTown.com has the right to amend this Agreement at any time without notice to you by making changes to this Agreement as posted. If any inconsistency exist between the terms of this Agreement and any additional terms and conditions posted on the Website, such terms will be interpreted as to eliminate any inconsistency, if possible, and otherwise, the additional terms and conditions will control.

The headings used in these terms of use are for convenience only and such headings are not to be used in determing the meaning or interpretation of these terms of use.

You agree that regardless of any statute or law to the contrary, any claim or cause of action arising from or out of use of the Website must be filed within one (1) year after such claim or cause of arose.

You acknowledge that the provisions, disclosures and disclaimers set forth in this Agreement are fair and reasonable and your agreement to follow and be bound by them is not the result of fraud, duress or undue influence exercised upon you by any person or entity. A printed version of this agreement will be admissible in any proceeding relating to this Agreement to the same extent as other business documents and records generated and maintained in printed, hard copy form. Notwithstanding any provisions of this Agreement, DentalTown.com has available all remedies at law or equity to enforce this Agreement. There are no representations, promises, warranties or undertakings by DentalTown.com contrary to those set forth above.

### HIPAA Compliance

To comply with the Health Insurance Portability and Accountability Act of 1996 (“HIPAA”), you agree that you will not submit any information or materials containing Protected Health Information (“PHI”). PHI is information or materials relating to an individual's medical condition or care and from which an individual can be identified. You further agree to indemnify, defend and hold harmless DentalTown.com and its affiliates and their respective officers, directors, agents and employees from, for and against any claim, demand or cause of action, including payments of reasonable attorneys' fees and costs arising out of or related to any violation of HIPAA or failure to comply with the terms of this section. If DentalTown.com determines that you have distributed PHI on the Website without de-identifying it as required by HIPAA, it will so notify you and may suspend or terminate your right to access the Website.

I HAVE READ THE FORGOING AGREEMENT AND AGREE TO BE BOUND BY ITS TERMS AND CONDITIONS.

### Privacy Policy

Your privacy concerns are important to DentalTown.com. This Policy is designed to provide you with the information you need to control your personal information.

1. You may use the DentalTown.com website without giving us information which identifies you, such as your name, address, telephone number, credit card and similar information. We refer to these types of information as “Personally Identifying Information”. To use certain portions of the Website, you will need to provide a user name and password. Your user name is not considered Personally Identifying Information. You are responsible for ensuring that your user name and password are not used without your authorization.

2. We collect Personally Identifying Information only if you voluntarily provide it on the website. If you do not wish to provide some or all of the information requested on a screen, or if you have concerns about maintaining the confidentiality of any information, do not provide it.

3. We may request general information, such as your State and zip code, in order to identify the sponsor for your area, and for statistical purposes. For convenience, this information may be stored on your hard drive in a “cookie file.” If you wish to block or delete such files, most browsers provide a method for doing so. This type of general information, as well as information concerning the websites from which users visit our site, and other similar information, may be provided to third parties in aggregate form.

4. We reserve the right to use, without Personally Identifying Information, any questions, comments or other information submitted by users in books, articles, commentaries, research or similar ways. Users may be identified by user name.

5. If you visit a website that is linked to the DentalTown website, you should consult that website's privacy policy before providing Personally Identifying Information. DentalTown.com is not responsible for the security procedures or data collection policy for any linked website. Accessing a linked site is at your own risk.

6. We will use Personally Identifying Information provided by you for the purpose for which it is given to us. For example, to respond to a request for further information, or to have a Sponsor contact you at your request. It also may be used by us, or by entities with which we contract, for transmission of newsletters and advertisements in which you may be interested, and for such other purposes that are disclosed at the time the information is given. If you receive information that you do not wish to receive, please contact us or follow the instructions for removing your name from the circulation list for that item.

7. DentalTown.com's policy is that the website may be used only by individuals over the age of 18, and we urge parents to supervise their children's use of the website. We do not collect any information from children. However, if a parent learns that a child has submitted Personally Identifying Information to our website, the parent should contact us and that information will be deleted.

8. In making your decision whether to provide Personally Identifying Information, you should be aware of the general risks of transmitting information over the Internet. Our website generally does not use encryption. While DentalTown.com attempts, to prevent unauthorized persons from accessing our files or tampering with our website, we cannot guarantee that these efforts will always be successful or that your information will not be lost, misused or altered. DentalTown.com is not responsible for any breach of security or any action by a third party that receives the information.

9. This Privacy Policy should be read in conjunction with the Terms of Use, which govern your use of the Website.

If you have any comments or questions about this Privacy Policy, please contact the web administrator at administrator@DentalTown.com.

What is claimed is:

1. A method of publishing a printed magazine comprising:
providing the magazine to a substantial portion of a vertical market comprising entities having interest in a common subject area;
printing in the magazine portions of selected threads from an online forum in the subject area; and
printing advertising in the magazine for at least one advertiser offering at least one product to at least some of the entities having interest in the common subject area.

2. The method according to claim 1 further comprising the step of:
providing an online forum in the subject area;
wherein the online forum allows a subset of such entities to be contributors to the threads.

3. The method according to claim 1 wherein the magazine is provided substantially free to the entities.

4. The method according to claim 2 wherein the online forum is provided substantially free to the entities.

5. The method according to claim 1 wherein contributors to the threads of the online forum comprise at least one subset of the entities.

6. The method according to claim 5 wherein the contributors agree to permit the magazine to print any content contributed to the threads.

7. The method according to claim 5 wherein the contributors agree that the online forum shall have rights to publish any content contributed to the online forum by the contributors.

8. The method according to claim 5 wherein it is a requirement of participation in the online forum that the entities agree to assign any intellectual property rights to the online forum for any content contributed to the online forum by the entities.

9. The method according to claim 2 wherein the entities must demonstrate qualification in the subject area to access the online forum.

10. The method according to claim 2 wherein the entities are required to correctly answer a qualifying question in the subject area before being allowed to participate in the online forum.

11. The method according to claim 1 wherein a criterion for selecting the threads from an online forum is the popularity of the threads.

12. The method according to claim 11 wherein the popularity of the threads is measured by the number of thread entries.

13. The method according to claim 11 wherein the popularity of the threads is measured by the number of entities contributing to the threads.

14. The method according to claim 1 wherein advertising in the magazine for products related to the portions of selected threads is available to advertisers proximally to the portions of selected threads in the magazine.

15. The method according to claim 2 wherein the online forum is substantially devoid of advertising.

16. The method according to claim 1 wherein the portions of selected threads are printed in the magazine in a format recognizably similar to threads in the online forum.

17. The method according to claim 1 wherein the portions of selected threads printed in the magazine comprise screen names of entities who contributed the portions of selected threads.

18. The method according to claim 1 wherein the portions of selected threads printed in the magazine comprise photographs of entities who contributed the portions of selected threads.

19. The method according to claim 1 wherein the portions of selected threads printed in the magazine comprise geographic locations of entities who contributed the portions of selected threads.

20. The method according to claim 1 wherein the portions of selected threads printed in the magazine comprise registration information of entities who contributed the portions of selected threads.

21. The method according to claim 1 wherein the portions of selected threads printed in the magazine comprise user profiles of entities who contributed the portions of selected threads.

22. The method according to claim 1 wherein the portions of selected threads printed in the magazine comprise thread information about the portions of selected threads.

23. The method according to claim 1 wherein the thread information comprises a post number.

24. The method according to claim 1 wherein the thread information comprises a total number of posts in the thread.

25. The method according to claim 1 wherein the thread information comprises times when the portions of selected threads were posted.

26. The method according to claim 1 wherein the portions of selected threads printed in the magazine are ordered chronologically.

27. The method according to claim 1 wherein a different background shade printed in the magazine is used to distinguish portions of selected threads contributed by different entities.

28. The method according to claim 1 wherein alternating background shades assist in distinguishing between posts successively printed in the magazine.

29. The method according to claim 5 wherein the portions of selected threads comprises at least three posts.

30. The method according to claim 1 wherein the common subject area is dentistry.

31. The method according to claim 1 wherein the vertical market is the vertical market of dentistry.

32. A system for publishing content comprising, in combination:
publishing means for providing a magazine to a substantial portion of a vertical market comprising entities having interest in a common subject area;
means for obtaining from an online forum in the subject area portions of selected threads in the subject area;
content means for printing in the magazine portions of the selected threads from an online forum in the subject area; and
advertising means for making advertising in the magazine available to advertisers desiring to offer products to the entities in the subject area.

33. A method of publishing content comprising, in combination, the steps of:
ranking online forum threads by popularity;
selecting at least one subset of popular topics for publication;
editing the content of the at least one subset; and
printing the content in at least one printed publication in a format recognizably similar to at least one format of the online forum.

34. The method according to claim 33 further comprising the step of providing at least one online forum.

35. The method according to claim 33 wherein the at least one printed publication is provided substantially free.

36. The method according to claim 33 wherein the at least one online forum is provided substantially free.

37. The method according to claim 33 wherein contributors to the at least one online forum agree in advance of contributing any content to the at least one online forum to permit the printing of content contributed to the threads.

38. The method according to claim 33 wherein popularity of the threads is measured by the number of thread entries.

39. The method according to claim 33 wherein popularity of the threads is measured by the number of different contributors to the threads.

40. The method according to claim 33 wherein advertising in the at least one printed publication for products related to the content is available to advertisers proximally to the content in the at least one printed publication.

41. The method according to claim 33 wherein the at least one online forum is substantially devoid of advertising.

42. The method according to claim 33 wherein the content comprises screen names of entities who contributed the content.

43. The method according to claim 33 wherein the printed content comprises thread information about the forum threads.

44. The method according to claim 43 wherein the thread information comprises a post number.

45. The method according to claim 43 wherein the thread information comprises a total number of posts in the thread.

46. The method according to claim 43 wherein the thread information comprises times(s) when the portions of selected threads were posted.

47. The method according to claim 33 wherein alternating background shades assist readers to identify content as originating from the at least one online forum.

48. The method according to claim 33 wherein the portions of selected threads comprise entries by at least three contributors.

49. A method of publishing content comprising:
providing at least one online forum;
selecting at least one subset of online subject matter from the at least one online forum for publication;
editing the content of the at least one subset of online subject matter; and
printing the content in a format recognizably similar to at least one format of the at least one subset of online subject matter.

50. A system for publishing content comprising, in combination:
means for providing at least one online forum;
means for selecting at least one subset of online subject matter from the at least one online forum for publication;
means for editing the content of the at least one subset of online subject matter; and
means for printing the content in a format recognizably similar to at least one format of the at least one subset of online subject matter.
